(19) United States
(12) Patent Application Publication
(10) Pub. No.: US 2022/0390873 A1
(43) Pub. Date: Dec. 8, 2022

(54) TWO-COMPONENT DEVELOPER FOR ELECTROSTATIC CHARGE IMAGE DEVELOPMENT, ELECTROPHOTOGRAPHIC IMAGE FORMING METHOD AND ELECTROPHOTOGRAPHIC IMAGE FORMING APPARATUS

(71) Applicant: Konica Minolta, Inc., Tokyo (JP)

(72) Inventors: Shinya OBARA, Tokyo (JP); Koji SHIBATA, Tokyo (JP); Ikuko SAKURADA, Tokyo (JP)

(21) Appl. No.: 17/825,127

(22) Filed: May 26, 2022

(30) Foreign Application Priority Data
Jun. 8, 2021 (JP) 2021-095921

(51) Int. Cl. G03G 9/097; G03G 15/08; G03G 9/113

(52) U.S. Cl. CPC G03G 9/09716; G03G 15/08; G03G 9/113

(57) ABSTRACT

Provided is a two-component developer for electrostatic charge image development including: toner particles containing toner base particles and an external additive disposed on a surface of the toner base particles; and carrier particles having a core material particle and a shell portion disposed on a surface of the core material particle, wherein the external additive contains inorganic particles surface-modified with a surface modifier represented by the following Formula (1); and a value of an iron element content (atomic %) measured by X-ray photoelectron spectroscopy (XPS) on a surface of the carrier particles satisfies the following Expression (1),

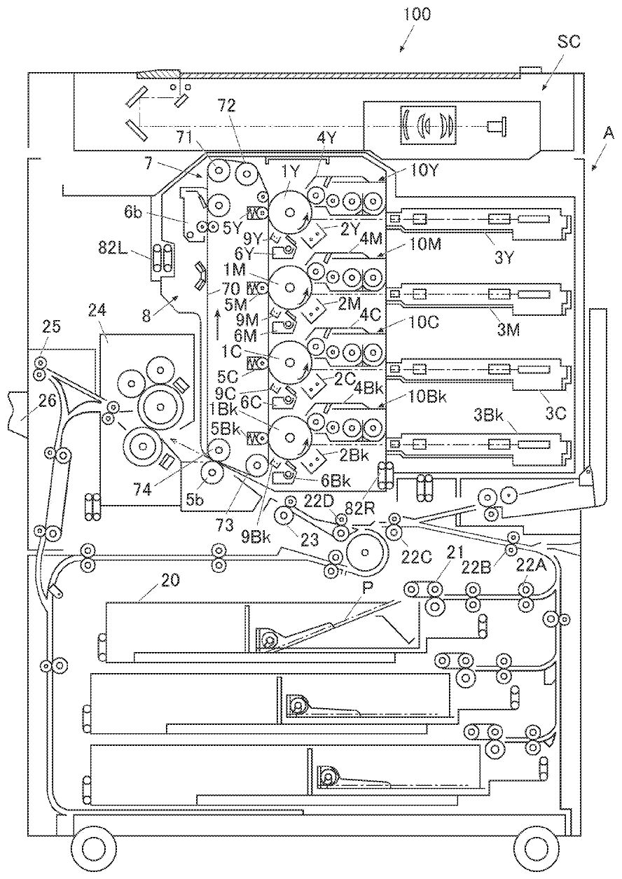

(R₁)₄₋ₙ—Si—(X)ₙ Formula (1):

4.0≤{A_{Fe}/(A_{c}+Aₒ+A_{Fe})}×100≤15.0 Expression (1):

### CROSS-REFERENCE TO RELATED APPLICATIONS

The entire disclosure of Japanese Patent Application No. 2021-095921 filed on Jun. 8, 2021 is incorporated herein by reference in its entirety.

### BACKGROUND

### Technological Field

The present invention relates to a two-component developer for electrostatic charge image development, an electrophotographic image forming method and an electrophotographic image forming apparatus using the same. More particularly, the present invention relates to a two-component developer for electrostatic charge image development that improves the charge rise of the toner for high-speed printing, and furthermore, stabilizes the charge amount of the toner even under environmental fluctuations, and stably outputs high-quality images during continuous printing.

### Description of the Related Art

With the widespread use of copiers and printers, the toner for electrostatic charge image development (hereinafter, also simply referred to as a “toner”) used for printing is required to have higher performance. In recent years, a digital printing technology called print-on-demand (POD), which does not require a plate-making process and prints directly, has been attracting attention. POD is more user-friendly than conventional offset printing because it can handle small-lot printing and variable printing with different printing contents for each sheet. The demand for high-speed printing and energy saving is increasing.

For high-speed printing and energy saving, it is necessary to improve the charge rise of the toner in order to obtain the desired toner charge amount by friction in a very short time. In addition, to achieve high reliability in toner charging, stable toner charge control is required to ensure that the toner charge amount at the developing site is always within the set range allowed by the process. In addition, under humid conditions, the toner charge amount may drop, causing the toner to develop white areas (also called “generation of fog”), and under dry conditions, the toner charge becomes excessive (also called “overcharge”), resulting in a decrease in image density. Therefore, there is a need to reduce the variation in toner charge amount in order to achieve stability in environmental changes. In toner manufacturing, there is an urgent need to develop high-quality toners with highly controlled charging characteristics.

In order to solve this problem, it has been proposed to stabilize the charge amount by using silica treated with alkylalkoxysilane having a relatively long carbon number (see, for example, Patent Document 1: JP-A 2013-235046). However, silica particles treated with alkylalkoxysilane having a relatively large carbon number tend to adhere to container, and when used in toners, toner fluidity tends to decrease. Furthermore, since the charge rise is slow, when continuously printing images with a high printing rate, the charge does not rise to the desired level, resulting in a low charge state, which tends to deteriorate image quality.

### SUMMARY

The present invention was made in consideration of the above-mentioned problems and circumstances, and the problem to be solved is to provide a two-component developer for electrostatic charge image development, an electrophotographic image forming method and an electrophotographic image forming apparatus, which can improve the rise in charge of the toner for high-speed printing, stabilize the charge amount of the toner under environmental changes, and stably output high-quality images during continuous printing.

In order to solve the above problem, the inventor found the following two-component developer for electrostatic charge image development in the process of studying the cause of the above problem. Namely, this two-component developer for electrostatic charge image development comprises toner particles containing toner base particles and an external additive, and carrier particles containing core material particles having a coating portion, wherein the external additive contains inorganic fine particles surface-modified with a specific surface-modifier, and moreover, the value of the iron element content derived from the core material particles on the surface of the carrier particles is within a specific range. We have found that this can solve the above problems, leading to the present invention.

The above problem is solved by the following means.

To achieve at least one of the above-mentioned objects of the present invention, a two-component developer for electrostatic charge image development that reflects an aspect of the present invention is as follows.

A two-component developer for electrostatic charge image development comprising: toner particles containing toner base particles and an external additive disposed on a surface of the toner base particles; and carrier particles having a core material particle and a shell portion disposed on a surface of the core material particle,

wherein the external additive contains inorganic particles surface-modified with a surface modifier represented by the following Formula (1); and

a value of an iron element content (atomic %) measured by X-ray photoelectron spectroscopy (XPS) on a surface of the carrier particles satisfies the following Expression (1),

(R₁)₄₋ₙ—Si—(X)ₙ Formula (1):

R₁ represents a linear alkyl group having 1 to 4 carbon atoms which may have a substituent; X is a halogen atom or an alkoxy group, and when there are a plurality of Xs, the plurality of Xs may be the same or different from each other; and n represents an integer of 1 to 3,

4.0≤{A_{Fe}/(A_{c}+Aₒ A_{Fe})}×100≤15.0 Expression (1):

A_{Fe}, A_{c}, and Aₒ, each represent a content (atomic %) of Fe, C, and C in an unit area of the surface of the carrier particles.

By the above means of the present invention, it is possible to provide a two-component developer for electrostatic charge image development, an electrophotographic image forming method, and an electrophotographic image forming apparatus, in which the charge rising property of the toner corresponding to high-speed printing is improved, the charge amount of the toner is stable even under environmental changes, and a high-quality image is stably output during continuous printing.

The expression mechanism or action mechanism of the effect of the present invention is not clear, but is speculated as follows.

The two-component developer for electrostatic charge image development of the present invention contains toner particles including toner base particles and an external additive disposed on the surface of the toner base particles, the external additive being characterized in that it contains inorganic fine particles represented by Formula (1), which are surface-modified with an alkylalkoxysilane surface modifier having a linear alkyl group with 1 to 4 carbon atoms.

Hexamethyldisilazane (HMD S) treatment, which is a commonly used surface modifier, has a low adhesive force, so that the toner may be made highly fluid, but since the adhesive force to the toner base particles is also weak, there is a problem of causing a decrease in the amount of charge due to carrier contamination. In addition, in a single-chain treatment agent such as HMDS, water molecules tend to approach unreacted OH groups, so that a charge leak occurs, and the charge amount tends to decrease particularly in a high temperature and high humidity environment.

On the other hand, when improving the adhesive force to the toner base particles by treatment with an alkylalkoxysilane, it is necessary to efficiently construct a state of polar groups in which transfer of electrons is likely to occur. However, when a long-chain alkyl group is introduced, the approach of water molecules may be prevented, but the long-chain alkyl group tends to cause excessive charging, especially in a low-temperature and low-humidity environment, because the long-chain alkyl group directly frictionally charges rather than by friction of the OH group coming into contact with the carrier.

Therefore, we considered that it is necessary to eliminate the influence of water and build an environment in which OH groups come into direct contact with carriers. As a result, we found that treating the surface of the external additive with alkoxysilane or halogenated silane having a linear alkyl group with 1 to 4 carbon atoms was preferable for charging.

In addition, the two-component developer for electrostatic charge image development of the present invention contains the toner particles and the carrier particles having a core material particle and a coating portion disposed on the surface of the core material particle, and the carrier particle surface has an iron element content (atomic %) derived from the core material particle as measured by X-ray photoelectron spectroscopy (XPS) in the range of 4.0 to 15.0.

When the outermost surface of the carrier particles is coated with a resin, the external additive that comes into contact with the particles tends to become overcharged, resulting in overcharging of the toner. In the overcharged state, that is, in the state where the saturated charge amount value is high, the toner and the carrier particles are electrostatically strongly adhered to each other, so that the toner replacement is deteriorated and the toner charge amount distribution is likely to be widened. Along with this, there is a problem that the concentration change is likely to occur remarkably.

On the other hand, when the core material particles are exposed on the surface of the carrier particles, the charge may leak out from the core material particles through discharge during frictional charging, thus suppressing the excessive charging mentioned above. However, if the exposed area of the core material particles is too large, the resistance becomes low and the charge leaks easily. Therefore, we found that by controlling the exposed area of the core material particles within a certain range, we can improve the charging rise of the toner. In the present invention, the exposed area of the core material particles is controlled by adjusting the value of the iron element content (atomic %) measured by X-ray photoelectron spectroscopy (XPS) on the surface of the carrier particles represented by the above Expression (1).

The above Expression (1) shows the relationship between the iron element content on the carrier particle surface. The main atoms on the surface of the carrier particles are carbon, oxygen and iron. The carbon is mainly derived from the resin. In the present invention, iron oxide material is used for the core material particles, so the iron is mainly derived from the core material. Expression (1) shows the percentage of iron among the main atoms (carbon, oxygen and iron) on the surface of the carrier particles, and by keeping this percentage within a specific range, the core material particles are adequately exposed on the surface of the carrier.

As described above, by treating the surface of the external additive with an alkoxysilane or halogenated silane having a linear alkyl group with 1 to 4 carbon atoms, and by controlling the exposed area of the core material particles in the carrier particles having a coated portion, it is possible to obtain a two-component developer for electrostatic charge image development, which may improve the charge rising property and stabilize the charge amount of the toner even under environmental changes such as humidity.

### BRIEF DESCRIPTION OF THE DRAWINGS

The advantages and features provided by one or more embodiments of the invention will become more fully understood from the detailed description given hereinbelow and the appended drawing which are given by way of illustration only, and thus are not intended as a definition of the limits of the present invention.

The FIGURE is a schematic diagram of the structure of the electrophotographic image forming apparatus.

### DETAILED DESCRIPTION OF THE EMBODIMENTS

Hereinafter, one or more embodiments of the present invention will be described. However, the scope of the invention is not limited to the disclosed embodiments.

The two-component developer for electrostatic charge image development of the present invention is a two-component developer for electrostatic charge image development including toner particles containing a toner base particle and an external additive disposed on the surface of the toner base particle, and carrier particles having a core material particle and a coating portion disposed on the surface of the core material particle, the external additive containing inorganic particles surface-modified with a surface modifier represented by Formula (1), and the iron element content rate (atomic %) measured by X-ray photoelectron spectroscopy (XPS) on the surface of the carrier particles satisfies the above Expression (1). This feature is a technical feature common to or corresponding to the following implementation.

It is preferred that the external additive is silica particles, alumina particles, or titanic acid compound particles, from the viewpoint of toner charge rise and improvement of toner charge amount stability and fluidity under environmental changes.

In addition, it is preferable that the shape factor (SF-1) of the core material particles is in the range of 115 to 150 from the viewpoint of improving the stability of the toner charge amount under environmental changes and transporting the toner to the developing nip section.

It is preferable that the toner base particles have a core-shell structure, where the core portion is mainly composed of an amorphous vinyl resin and the shell portion is mainly composed of an amorphous polyester resin, from the viewpoint of low temperature fixability of the toner and stability improvement of the toner charge amount under environmental changes.

The electrophotographic image forming method of the present invention (hereinafter also referred to as an “image forming method”) is an electrophotographic image forming method having at least the following steps: charging of an image carrier, forming an electrostatic charge image, developing an electrostatic charge image, transferring a toner image, and fixing the toner image.

It is characterized by using the two-component developer for electrostatic charge image development of the present invention.

In addition, the electronic image forming apparatus of the present invention (hereinafter also referred to as an “image forming apparatus”) is an electrophotographic image forming apparatus that is at least equipped with a charging unit of an image carrier, an electrostatic charge image forming unit, an electrostatic charge image developing unit, a toner image transferring unit, a toner image fixing unit, and a cleaning unit, wherein the electrophotographic image forming apparatus uses the two-component developer for electrostatic charge image development according to the present invention.

Hereinafter, the present invention, its constituent elements, and modes and embodiments for carrying out the present invention will be described in detail. In addition, in this application, “to” is used in the meaning which includes the numerical values described before and after “to” as the lower limit value and the upper limit value.

### <<Outline of the Two-Component Developer for Electrostatic Charge Image Development of the Present Invention>>

The two-component developer for electrostatic charge image development (hereinafter simply referred to as a “two-component developer”) of the present invention is a two-component developer for electrostatic charge image development including toner particles containing a toner base particle and an external additive disposed on the surface of the toner base particle, and carrier particles having a core material particle and a coating portion disposed on the surface of said the core material particle.

The external additive is characterized in that it contains inorganic fine particles that have been surface-modified with a surface-modifier represented by the following Formula (1), and that the value of the iron element content (atomic %) measured by X-ray photoelectron spectroscopy (XPS) satisfies the following Expression (1).

(R₁)₄₋ₙ—Si—(X)ₙ Formula (1):

R₁ represents a linear alkyl group having 1 to 4 carbon atoms which may have a substituent; X is a halogen atom or an alkoxy group, and when there are a plurality of Xs, the plurality of Xs may be the same or different from each other; and n represents an integer of 1 to 3,

4.0≤{A_{Fe}/(A_{c}+Aₒ+A_{Fe})}×100≤15.0 Expression (1):

A_{Fe}, A_{c}, and Aₒ, each represent a content (atomic %) of Fe, C, and C in an unit area of the surface of the carrier particles.

The two-component developer for electrostatic charge image development of the present invention (hereinafter also referred to as a “toner”) includes toner particles containing a toner base particle and an external additive disposed on the surface of the toner base particle.

In the present specification, the “toner base particle” constitutes the base of the “toner particle”. The “toner base particle” according to the present invention contains at least a binder resin, and also contains other constituent components such as a colorant, a mold release agent (wax), and a charge control agent, if necessary. “Toner base particles” are referred to as “toner particles” due to the addition of an external additive. The “toner” refers to an aggregate of toner particles.

Furthermore, the two-component developer for electrostatic charge image development of the present invention contains, in addition to the toner particles, carrier particles containing a core material particle having a coating portion disposed on the surface of the core material particle to constitute a two-component developer.

First, the constituent elements of the present invention will be described in detail from the carrier particles.

### [1] Carrier Particles

The two-component developer for electrostatic charge image development is used as a two-component developer by mixing toner particles and carrier particles. Examples of the carrier particles include magnetic particles made of conventionally known materials such as iron, ferrite, magnetite and other metals, and alloys of the metals with aluminum, lead and other metals. Examples of the carrier particles include coated carrier particles having a core material particle made of a magnetic material and a coating material covering the surface of the core material particle, and resin-dispersed carrier particles in which a fine powder of a magnetic material is dispersed in a resin. The carrier particles are preferably coated carrier particles from the viewpoint of suppressing the adhesion of the carrier particles to the photoreceptor.

The core material particle is, for example, a magnetic material that is strongly magnetized in that direction by a magnetic field. One type of magnetic material may be used alone, or two or more types may be used together. Examples of the magnetic material include metals that exhibit ferromagnetism, such as iron, nickel and cobalt, alloys or compounds containing these metals, and alloys that exhibit ferromagnetism when heat treated.

Examples of the metal or the compound containing a metal that exhibits ferromagnetism include iron, ferrite represented by Formula (a) below, and magnetite represented by Formula (b) below. M in Formula (a) and Formula (b) represents one or more of monovalent or divalent metals selected from the group consisting of manganese (Mn), magnesium (Mg), strontium (Sr), calcium (Ca), titanium (Ti), copper (Cu), zinc (Zn) Zinc (Zn), Nickel (Ni), Aluminum (Al), Silicon (Si), Zirconium (Zr), bismuth (Bi), cobalt (Co), and lithium (Li).

MO.Fe₂O₃ Formula (a):

M Fe₂O₄ Formula (b):

Examples of the alloy that exhibits ferromagnetism include Heusler alloys such as manganese-copper-aluminum and manganese-copper-tin, and chromium dioxide.

Various ferrites are preferred for the core material particles. The specific gravity of the coated carrier particles is smaller than that of the metals that constitute the core material particles. Therefore, various ferrites may reduce the impact force of agitation in the developer.

The coating portion is located on the surface of the core material particles. The coating portion has a coating material. One type of coating material may be used alone, or two or more types may be used together. The coating material may be a known resin used to coat the core material particles in carrier particles. Examples of the resin used as a coating material include polyolefin resins such as polyethylene and polypropylene; polystyrene resins; (meth)acrylic resins such as polymethyl methacrylate; polyvinyl resins and polyvinylidene resins such as polyacrylonitrile, polyvinyl acetate, polyvinyl alcohol, polyvinyl butyral, and polyvinyl chloride; copolymer resins such as vinyl chloride-vinyl acetate copolymers and styrene-acrylic acid copolymers; silicone resins or modified resins composed of organosiloxane bonds; fluorinated resins such as polyfluorinated vinyl resins; polyamide resins; polyester resins; polyurethane resins; polycarbonate resins; amino resins such as urea-formaldehyde resins; and epoxy resins. Examples of the modified resin include modified resins by alkyd resins, polyester resins, epoxy resins, and polyurethanes.

For the resin used as a coating material, a resin with a cycloalkyl group is preferable from the viewpoint of reducing the water adsorption of the carrier particles and improving the adhesion to the core material particles in the coating portion. Examples of the cycloalkyl group include cyclohexyl, cyclopentyl, cyclopropyl, cyclobutyl, cycloheptyl, cyclooctyl, cyclononyl, and cyclodecyl groups. The cycloalkyl group is preferably a cyclohexyl group or a cyclopentyl group, and the cyclohexyl group is even more preferable from the viewpoint of adhesion between the coating portion and the core material particles.

The weight average molecular weight (Mw) of the resin with cycloalkyl groups is preferably 10,000 to 800,000, and 100,000 to 7500,000 is more preferable. The content of the constituent units containing cycloalkyl groups in the resin is, for example, 10 to 90 mass %. The content of cycloalkyl groups in the resin may be determined by known instrumental analysis methods, such as P-GC/MS and ¹H-NMR.

In the carrier particles according to the present invention, when the core material particles are coated with a resin, the toner does not scatter and a stable image density may be obtained. However, when the core material particles are completely covered with a resin, the resistance of the carrier particles becomes high because the core material particles made of magnetic material are not exposed. Therefore, the carrier material particles need to be initially coated with a resin so that the core material particles are moderately exposed.

The exposed area (degree of exposure) of the core material particles on the surface of the carrier particles of the present invention is achieved by adjusting the iron element content (atomic %) measured by X-ray photoelectron spectroscopy (XPS) on the surface of the carrier particles to satisfy the following Expression (1).

4.0≤{A_{Fe}/(A_{c}+Aₒ A_{Fe})}×100≤15.0 Expression (1):

Here, A_{Fe}, A_{c}, and Aₒ, each represent a content (atomic %) of Fe, C, and C in an unit area of the surface of the carrier particles.

Here, “initial” refers to the stage when the toner particles and carrier particles are mixed to produce a two-component developer for electrostatic charge image development. When the iron element content is less than 4.0 atomic %, the resistance value of the carrier particles becomes too high, and the electrostatic adhesion between the carrier particles and toner particles increases, and the replacement of toner particles becomes poor, causing fog and degradation of image quality. On the other hand, when the iron element content is more than 15.0 atomic %, the resistance of the carrier particles themselves decreases, which lowers the charge amount of the toner particles and causes deterioration of image quality.

Similarly, when the material of the core material particles is other than the iron oxide-based material, the carrier may be prepared by setting the value of the element content shown below within a specific range in the main elements contained in the material of the core material particles. It is considered that the core material particles are appropriately exposed on the surface of the surface, and the same effect may be obtained.

Expression (2) below shows the percentage of iron among the main elements (carbon, oxygen and iron) on the surface of the carrier particles (also referred to as an “iron element content”). By keeping this ratio within a specific range, the core material particles are adequately exposed on the surface of the carrier particles.

Iron element content (atomic %)=A_{Fe}/(A_{c}+Aₒ+A_{Fe}) Expression (2):

Here, A_{Fe}, Aₑ and Aₒ represent the content (atomic %) of Fe, C and O in a unit area of the surface of the carrier particles, respectively.

The iron element content expressed in Expression (2) may be measured by the following method.

In surface elemental composition analysis by X-ray photoelectron spectroscopy (XPS), the CIs spectrum for carbon, the Fe2p_{3/2} spectrum for iron, and the O1s spectrum for oxygen are measured. Based on the spectra of each of these elements, the contents (atomic %) of Fe, C and O in the unit area of the carrier surface represented by “A_{C}”, “A_{O}” and “A_{Fe}” are obtained, and Expression (2) is used for calculation.

For the XPS measurement system, K-Alpha (manufactured by Thermo Fisher Scientific) is used. Al monochromatic X-rays are used as an X-ray source, with an acceleration voltage of 7 kV and an emission current of 6 mV.

The volume average particle diameter of the carrier particles is preferably in the range of 20 to 100 μm in terms of median diameter on a volume basis, and a range of 5 to 80 μm is more preferable. The volume-based median diameter of the carrier particles is measured, for example, by using a laser diffraction type particle size distribution measuring device (HELOS; SYPATEC Corporation) equipped with a wet disperser or a method for measuring the volume-based median diameter of toner particles, which will be described later.

The shape coefficient (SF-1) of the core material particles is preferably 115 or more and 150 or less. When the shape coefficient is 115 or more, the measured particle shape does not become close to a true sphere, so the bulk density (g/cc) of the carrier does not become too large. It has an advantage that a two-component developer for electrostatic charge images development is not excessively transported in the developing nip, and fog and toner scattering are unlikely to occur.

On the other hand, when the shape factor is 150 or less, the undulations of the surface of the core material particles are moderate, and voids are not easily generated inside the core material particles, so the core material particles may be suppressed from containing moisture according to the humidity. Therefore, there is no significant decrease in charge retention capacity due to the decrease in resistance per particle caused by such moisture, and the occurrence of problems such as fog development may be suppressed.

By being within the above range, the surface of the core material particles is moderately uneven, so the value of the iron element content expressed in Expression (2) may be adjusted to within the above range in the resin-coated carrier. By increasing the shape factor, the unevenness of the core material particles becomes larger, making it easier to expose the core material particles, and the value of the iron element content expressed in Expression (2) also becomes larger.

The shape factor of the core material particles is measured by the following method. A scanning electron microscope is used to take photographs of more than 100 particles randomly at 150× of the carrier core material. The captured photographic images are analyzed using the LUZEX AP image processing analyzer (Nireco, Inc.) to measure the maximum length and projected area of the core material particles. The “maximum length” means the maximum length of the image of a particle. The shape coefficient is a value calculated by the average value of the shape coefficient SF-1 calculated by the following Expression in 100 core material particles.

SF-1=(Maximum length of the particle)²/(Projected area of the particle)×(π/4)×100 Expression (3):

In order to produce core material particles with a shape factor of 115 to 150, the sintering temperature in the sintering process is preferably set to 1,300 to 1,500° C., which is higher than the conventional method.

The dynamic resistivity of the carrier particles is preferably between 1.0×10⁸ Ω·cm or more and 1.0×10¹¹ Ω·cm or less. When the dynamic resistivity of the carrier particles is 1.0×10⁸ Ω·cm or more, the charge retention capacity of the carrier particles themselves does not deteriorate and the toner particles may maintain their charge amount. On the other hand, when the dynamic resistivity of the carrier particles is 1.0×10⁸ Ω·cm or less, the electrostatic charge between the toner particles and the carrier particles becomes appropriate without accumulating the charge of the opposite electrode to the toner particles on the carrier particles, and the replacement of the toner particles is improved. Therefore, it is possible to suppress fog and deterioration of image quality.

The dynamic resistivity of carrier particles is determined by the following method. An aluminum electrode drum having the same dimensions as the photoreceptor drum is replaced with the photoreceptor drum, carrier particles are supplied onto the developing sleeve to form a magnetic brush, and the magnetic brush is rubbed against the electrode drum, then, a voltage (500 V) is applied between the sleeve and the drum, and the current flowing between them is measured. The dynamic resistivity of the carrier particles is calculated by the following Expression (4).

DVR(Ω·cm)=(V/I)×(N×L/Dsd) Expression (4):

DVR: Carrier resistance (Ω·cm)

V: Voltage between developing sleeve and photoreceptor drum (V)

I: Measured current value (A)

N: Width of developing nip (cm)

L: Length of developing sleeve (cm)

Dsd: Distance between developing sleeve and photoreceptor drum (cm)

For example, the measurement may be done with: V=500 V, N=1 cm, L=6 cm, and Dsd=0.6 mm.

Examples of the method for producing coated carrier particles having a core material particle and a coating portion include a wet coating method and a dry coating method. Examples of the wet coating include a fluidized bed spray coating method, an immersion coating method, and a polymerization methods.

In the “fluidized bed spray coating method”, a coating liquid in which a resin used as a coating material is dissolved in a solvent is spray-coated on the surface of magnetic particles using a fluidized bed, and then dried to prepare a coating portion. The “immersion coating method” is a method in which magnetic particles are immersed in a coating liquid in which a resin used as a coating material is dissolved in a solvent, coated, and dried to prepare a coated portion. In the polymerization method, magnetic particles are dipped into a coating solution in which a reactive compound is dissolved in a solvent, and then polymerized by applying heat to prepare a coating portion.

In the dry coating method, a resin used as a coating material is adhered to the surface of the core material particles, and then mechanical impact force is applied to melt or soften the resin adhered to the surface of the core material particles to create a coating portion. Specifically, the core material particles, the resin used as a coating material, and low-resistance fine particles are mixed at high speed using a high-speed agitator capable of applying mechanical impact force under unheated or heated conditions, and impact force is repeatedly applied to the mixture to create a carrier that is melted or softened and adhered to the surface of the magnetic particles. As the conditions for coating, 80 to 130° C. is preferable when heating. The wind speed at which the impact force is applied is preferably 10 m/s or higher during heating, and 5 m/s or lower during cooling from the viewpoint of suppressing the aggregation of carrier particles. The time for applying the impact force is preferably 20 to 60 minutes.

A two-component developer may be obtained by mixing the toner particles according to the present invention with the carrier particles. There are no particular limitations on the mixing equipment used in the mixing process. Examples of the mixing device include a Nauta mixer, a W-cone, and a V-type mixer. The content of toner particles (toner concentration) in the two-component developer for electrostatic charge image development is not particularly limited, but 4.0 to 8.0 mass % is preferable.

### [2] Toner Particles

The two-component developer for electrostatic charge image development of the present invention contains toner particles including toner base particles and an external additive disposed on the surface of the toner base particles.

### [2.1] External Additive

The external additive according to the present invention contains inorganic fine particles that have been surface-modified with a surface-modifier represented by the following Formula (1).

(R₁)₄₋ₙ—Si—(X)ₙ Formula (1):

R₁ represents a linear alkyl group having 1 to 4 carbon atoms which may have a substituent; X is a halogen atom or an alkoxy group, and when there are a plurality of Xs, the plurality of Xs may be the same or different from each other; and n represents an integer of 1 to 3.

For the rise of charge, it is effective to use a polar group that easily transfers electrons, but in a short-chain surface modifier such as the HMDS treatment, water molecules tend to approach the unreacted OH groups on the surface of the external additive, so that charge leakage occurs preferentially over charge rise.

On the other hand, when a long-chain alkyl group (C6 or more) is introduced, water molecules may be prevented from approaching, but since a high-resistance alkyl group is introduced on the outermost surface, the probability of frictional charging between the long-chain alkyl group and the carrier increases. The transfer of electrons is unlikely to occur in a chain, and the rise in charge is delayed.

Alkoxysilanes and halogenated silanes having a linear alkyl group having 1 to 4 carbon atoms may suppress the approach of water molecules due to the three-dimensional structure of the alkyl group, the halogen atom, and the alkoxy group. In addition, the electron transfer from the alkyl group to the polar group due to the formation of a hydrogen bond network between the alkoxy group and the unreacted OH group becomes smooth, and the charge rising property is remarkably improved.

The electrostatic adhesion of the external additive in contact with the resin-coated part of the outermost surface of the carrier particles improves the fluidity of the carrier particles, increases the number of frictional charges with the toner and external additive per unit time, and speeds up the charge rise rate, but the saturation charge value tends to be high. On the other hand, by exposing the carrier core material particles, excess charge may be leaked by discharge, thereby suppressing excessive charging.

As an external additive according to the present invention, conventionally known metal oxide particles may be used as the inorganic fine particles. Examples thereof include silica particles, alumina particles, titanic acid compound particles, zirconia particles, zinc oxide particles, chromium oxide particles, cerium oxide particles, antimony oxide particles, tungsten oxide particles, tin oxide particles, tellurium oxide particles, manganese oxide particles, and boron oxide particles. These may be used alone or in combination of two or more types.

Among them, silica particles, alumina particles, or titanic acid compound particles are preferred. Silica particles are effective in improving toner fluidity, and therefore have a good charge rise and may be charged uniformly. On the other hand, titania particles, because of their low resistivity, have good charging rise, but have a problem of charge retention under high temperature and high humidity conditions, resulting in a drop in the amount of charge. Alumina particles and titanic acid compound particles are characterized by sufficiently lower resistance than silica particles and higher resistance than titania particles. Therefore, compared to silica particles, charge transfer may occur more easily, resulting in a good charge rise. Since they have a higher resistance than titania particles, charge leakage is also less likely to occur, thus enabling a more uniform toner charge amount.

### (Silica Particles)

As silica, those prepared by a known method such as a sol-gel method, a gas phase method, and a fusing method may be used. In the method for producing silica by the sol-gel method, a tetraalkoxysilane as a raw material and an alkali catalyst as a catalyst are supplied in the presence of an alcohol containing an alkali catalyst, and the tetraalkoxysilane is reacted. This is a method for producing silane particles. It has the feature that it is easy to control the particle size distribution and shape.

In the gas phase method (gas combustion method), silicon chloride is vaporized and silica is synthesized by gas phase reaction in a high temperature hydrogen flame. In the fusing method, In the melting method, a mixed raw material composed of finely pulverized silica stone, a reducing agent such as metal silicone powder or carbon powder, and water for forming a slurry are heat-treated at a high temperature under a reducing atmosphere to obtain SiO gas. Silica is obtained by promptly cooling it in an atmosphere containing oxygen.

### (Alumina Particles)

Alumina refers to aluminum oxide, expressed as Al₂O₃, and is known in a, y, a, and mixed forms. The shapes range from cubic to spherical depending on the control of the crystal system. Alumina may be fabricated using known methods. The Bayer process is generally used as a method for producing alumina. In order to obtain high-purity and nano-sized alumina, a hydrolysis method, a gas phase synthetic method, a flame hydrolysis method, and an underwater spark discharge method may be mentioned.

### (Titanic Acid Compound Particles)

Typical titanic acid compounds used in the titanic acid compound particles of the present invention are, for example, compounds represented by the following Formula, which are so-called metatitanates produced from titanium (IV) oxide and other metal oxides or metal carbonates.

MI₂TiO₃ or MIITiO₂ Formula (2):

In Formula (2), MI represents a monovalent metal atom and MII represents a divalent metal atom.

The titanic acid compound that may be used in the present invention is preferably a titanic acid compound with a structure bonded to a divalent metal atom represented by MIITiO₃. Specific examples of the titanic acid compounds bonded with a divalent metal atom include calcium titanate (CaTiO₃), magnesium titanate (MgTiO₃), strontium titanate (SrTiO₃), and barium titanate (BaTiO₃). Among these titanic acid compounds bonded with a divalent metal atom, calcium titanate (CaTiO₃) is preferred from the viewpoint of environmental impact and maintaining a constant level of charge over a long period of time.

The titanic acid compounds that may be used in the present invention may be prepared by known methods. For example, there is a method of preparing titanic acid compounds that may be used in the present invention through a titanium (IV) oxide compound in the form of a hydrate called metatitanic acid, TiO₂.H₂O. In this method, the titanium (IV) oxide compound is reacted with a carbonate metal salt or metal oxide such as calcium carbonate, and then calcined to produce a titanic acid compound represented by calcium titanate. Titanium dioxide hydrolysate, such as metatitanic acid, is also called mineral acid deflocculate, and has a form of a liquid in which titanium dioxide particles are dispersed. A water-soluble metal carbonate or metal oxide is added to the mineral acid deflocculated product made of this titanium oxide hydrolyzate, and the mixture is heated to 50° C. or higher and reacted while adding an alkaline aqueous solution to form a titanium acid compound.

Metatitanic acid, which is one of the representative examples of mineral acid deflocculated products, has a sulfite (SO₃) content of 1.0 mass % or less, preferably 0.5 mass % or less, and is subjected to a deflocculation treatment by adjusting pH to 0.8 to 1.5 with hydrochloric acid.

As an alkaline aqueous solution used for producing the titanic acid compound, a caustic alkaline aqueous solution typified by a sodium hydroxide aqueous solution is preferable. The compounds to be reacted with the hydrolyzed titanium dioxide include nitric acid compounds, carbonate compounds, and chloride compounds of strontium, magnesium, calcium, barium, aluminum, zirconium, and sodium.

In the process of producing titanium acid compound particles, by adjusting the addition ratio of titanium oxide hydrate or hydrolyzate to metal oxide, the concentration of titanium oxide hydrate or hydrolyzate during the reaction, and the temperature and addition rate when adding the alkaline aqueous solution, the particle size of the titanic acid compound particles may be controlled. It is preferable to conduct the reaction under a nitrogen gas atmosphere to prevent the formation of carbonic acid compounds during the reaction process.

The higher the temperature at which the aqueous alkali solution is added, the more crystalline the product will be, but for practical use, a range between 50° C. and 101° C. is appropriate. The addition speed of the aqueous alkali solution tends to affect the particle size of the obtained titanic acid compound particles. The slower the addition speed, the larger the particle size of the titanic acid compound particles, and the faster the addition speed, the smaller the particle size tends to be formed. The addition rate of the aqueous alkali solution is 0.001 to 1.0 equivalents/hour, preferably 0.005 to 0.5 equivalents/hour, relative to the raw material to be prepared. It may be adjusted appropriately according to the desired particle size. The addition rate of the aqueous alkali solution may be changed during the process according to the purpose.

The toner of the present invention may further contain other known external additives as external additives. These inorganic fine particles may be treated with a glossy treatment or a hydrophobization treatment by a silane coupling agent, titanium coupling agent, higher fatty acid, and silicone oil to improve heat-resistant storage and environmental stability.

In addition, organic fine particles may also be used as other external additives. Specifically, organic fine particles made of styrene, methyl methacrylate, or other single polymer or copolymers of these materials may be used.

Lubricants may also be used as external additives. Lubricants are used to further improve cleaning property and transferability. Examples thereof include metal salts of higher fatty acids such as zinc, aluminum, copper, magnesium, and calcium salts of stearic acid; zinc, manganese, iron, copper, and magnesium salts of oleic acid; zinc, copper, magnesium, and calcium salts of palmitic acid; zinc, and calcium salts of linoleic acid; and zinc, calcium salts of ricinoleic acid.

### (External Processing)

Mechanical mixing devices may be used for the external additive mixing process of external additives to the toner base particles described below. As mechanical mixing devices, a Henschel mixer, a Nauta mixer, and a turbulence mixer may be used. Among these, a mixing device capable of imparting shearing force to the particles to be treated, such as a Henschel mixer, may be used to perform the mixing process by increasing the mixing time or increasing the rotational peripheral speed of the agitator blades. When multiple types of external additives are used, the toner particles may be mixed and treated with all of the external additives at once or divided and mixed multiple times depending on the external additives.

As for the mixing method of the external additive, the degree of crushing and the adhesion strength of the external additive are controlled by controlling the mixing strength, that is, the peripheral speed of the stirring blade, the mixing time, and the mixing temperature using the above mechanical mixing device.

The total amount of these external additives added is preferably in the range of 0.1 to 10 mass %, more preferably in the range of 1 to 5 mass %, based on 100 parts by mass of the toner base particles.

### [2.2] Toner Base Particles

It is preferable that the toner base particles of the present invention contain, at least as a binder resin, a vinyl resin as an amorphous resin from the viewpoint of improving the low-temperature fusing performance of the toner and the charge amount stability of the toner under environmental changes. That is, it is preferable that the toner base particles contain a binder resin having vinyl groups.

In order to contain the binder resin having a vinyl group in the toner base particles, an example of preferable embodiments is as follows. In this embodiment, the toner base particles have a core-shell structure, and in the core-shell structure, the core portion is mainly composed of an amorphous vinyl resin, and the shell portion is mainly composed of an amorphous polyester resin.

That is, it is preferable that the toner base particles have a core-shell structure. By adopting a core-shell structure, an interface exists between the core and the shell, as a result, when the incompatibility is high, the charge generated during toner charging is efficiently trapped and charge leakage may be prevented, and by increasing the compatibility, the degree of charge leakage may be controlled. The shell portion is not limited to completely covering the core particles, and the surface of the core particles may be partially exposed. The core-shell structure may be confirmed by observing the cross-sectional structure of the toner using known means such as transmission electron microscopy (TEM) and scanning probe microscopy (SPM).

The main component of the resin that constitutes the core portion is an amorphous vinyl resin, and the main component of the resin that constitutes the shell portion is preferably an amorphous polyester resin. Here, the “main component” means that it contains 55 mass % or more of the total amount of the constituent resins, preferably 70 mass % or more, and more preferably 80 mass % or more.

The degree of compatibility between the core resin and the shell resin may be controlled by changing the composition of the core resin and the shell resin, such as by using styrene-acrylic resin for the core resin and polyester resin for the shell resin, or by introducing a styrene-acrylic resin unit into a polyester resin. In addition, the toner base particles of the present invention may contain other components such as a colorant, a mold release agent (waxes), and a charge control agent, as necessary.

### [2.2.1] Binder Resin

<Amorphous resin>

### (Vinyl Resin)

The vinyl-based resin according to the present invention is not particularly limited as long as it is a polymerized vinyl compound. Examples thereof include a (meth)acrylate resin, a styrene-(meth)acrylate resin, and an ethylene-vinyl acetate resin. One of these may be used alone, or two or more may be used in combination.

Among the above vinyl resins, a styrene-(meth)acrylate resin is preferred in consideration of its plasticity during heat fixing. Therefore, in the following, a styrene-(meth)acrylate resin as an amorphous resin (hereinafter also referred to as a “styrene-(meth)acryl resin”) will de described.

An amorphous resins is one that does not have a clear endothermic peak in differential scanning calorimetry (DSC). That is, it usually does not have a melting point (a clear endothermic peak in a DSC curve measured using a differential scanning calorimetry (DSC) device) and have a relatively high glass transition point (Tg). More specifically, the Tg of the amorphous resin by differential scanning calorimetry is preferably in the range of 35 to 70° C., and more preferably, it is in the range of 50 to 65° C. When the Tg of the amorphous resin is 35° C. or higher, sufficient thermal strength may be given to the toner, and sufficient heat-resistant storage property may be obtained. Further, when the Tg of the amorphous resin is 70° C. or lower, sufficient low temperature fixability may be surely obtained.

The Tg of amorphous resins is measured by the method specified in ASTM D3418-82 (DSC method). Specifically, 4.5 mg of the measurement sample (amorphous resin) is weighed to two decimal places, sealed in an aluminum pan, and measured with a differential scanning calorimeter “DSC8500” (PerkinElmer Co. Ltd.). An empty aluminum pan is used as a reference. Temperature control of Heat-Cool-Heat is performed at a measurement temperature of −10 to 120° C., a temperature rise rate of 10° C./min, and a temperature drop rate of 10° C./min, and analysis is performed based on the data of the second temperature rise. The value of the intersection of the extension of the baseline before the rise of the first endothermic peak and the tangent line indicating the maximum slope from the rising portion of the first endothermic peak to the peak apex is defined as a glass transition point.

A styrene-(meth)acrylic resin is formed by addition polymerization of at least a styrene monomer and a (meth)acrylic ester monomer. The styrene monomer referred to here includes those having a known side chain or functional group in the styrene structure, in addition to the styrene represented by the structural formula of CH₂═CH—C₆H₅.

The (meth)acrylic acid ester monomer herein includes not only acrylic acid esters and methacrylic acid esters represented by CH₂═CHCOOR (R is an alkyl group), but also esters having known side chains or functional groups in the structure, such as acrylic acid ester derivatives and methacrylic acid ester derivatives. In the present specification, the term “(meth)acrylic ester monomer” is a generic term for “acrylic ester monomer” and “methacrylic ester monomer.

Examples of the styrene monomer and the (meth)acrylic ester monomer that may form a styrene-(meth)acrylic resin are shown below.

Specific examples of the styrene monomer include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene. These styrene monomers may be used alone or in combination of two or more.

Specific examples of the (meth)acrylic ester monomer include acrylic ester monomers such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; and methacrylic ester monomers such as methyl methacrylate, ethyl methacrylate, n-butyl methacrylate, isopropyl methacrylate, isobutyl methacrylate, ethyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate. These (meth)acrylic acid ester monomers may be used alone or in combination of two or more.

The content of the constituent unit derived from the styrene monomer in the styrene-(meth)acrylic resin is preferably in the range of 40 to 90 mass % relative to the total amount of the resin. The content of the constituent unit derived from the (meth)acrylic ester monomer in the resin is preferably in the range of 10 to 60 mass % relative to the total amount of the resin. Furthermore, the styrene-(meth)acrylic resin may contain the following monomer compounds in addition to the above styrene monomer and (meth)acrylic ester monomer.

Examples of such a compound include compounds having a carboxy group such as acrylic acid, methacrylic acid, maleic acid, itaconic acid, fumaric acid, maleic acid monoalkyl ester, and itaconic acid monoalkyl ester; and compounds having a hydroxy group such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. These monomer compounds may be used alone or in combination of two or more.

The content of the constituent units derived from the above monomer compounds in the styrene-(meth)acrylic resin is preferably in the range of 0.5 to 20 mass % of the total amount of the resin. The weight average molecular weight (Mw) of styrene-(meth)acrylic resin is preferably in the range of 10,000 to 100,000.

The molecular weight of styrene-(meth)acrylate resin is a weight average molecular weight (Mw) calculated from the molecular weight distribution measured by gel permeation chromatography (GPC), and the molecular weight measurement by GPC is performed as follows.

The device “HLC-8320” (manufactured by Tosoh Corporation) and the columns “TSKgel guardcolumn SuperHZ-L” and “TSKgel SuperHZM-M” are used. While maintaining the column temperature at 40° C., tetrahydrofuran (THF) is flowed as a carrier solvent at a flow rate of 0.2 ml/min. The measured sample (crystalline polyester resin) is dissolved in tetrahydrofuran to a concentration of 1 mg/ml under dissolution conditions of 5 minutes using an ultrasonic disperser at room temperature. Then, it is treated with a membrane filter having a pore size of 0.2 μm to obtain a sample solution. 10 μL of this sample solution is injected into the device together with the carrier solvent described above, and detected using a refractive index detector (RI detector) to determine the molecular weight distribution of the measured sample. The molecular weight distribution of the measurement sample is calculated using a calibration curve measured using monodisperse polystyrene standard particles.

The standard polystyrene samples for calibration curve measurement are those manufactured by Pressure Chemical Corporation. The used polystyrene standard particles have a molecular weight of 6×10², 2.1×10¹, 4×10³, 1.75×10⁴, 5.1×10⁴, 1.1×10⁵, 3.9×10⁵, and 8.6×10⁵, 2×10⁶, and 4.48×10⁶ respectively. At least 10 standard polystyrene samples are measured to prepare a calibration curve.

The method of producing styrene-(meth)acrylic resin is not particularly limited. Examples of the method use any polymerization initiator such as peroxide, persulfide, persulfate, and azo compounds, which are normally used in the polymerization of the above monomers. Examples of the polymerization method include known polymerization methods such as bulk polymerization, solution polymerization, emulsion polymerization method, miniemulsion method and dispersion polymerization method. Further, a commonly used chain transfer agent may be used for the purpose of adjusting the molecular weight. The chain transfer agent is not particularly limited. For example, alkyl mercaptans such as n-octyl mercaptan, and mercapto fatty acid esters such as n-octyl-3-mercaptopropionate may be mentioned.

### (Amorphous Polyester Resin)

An amorphous polyester resin is obtained by polycondensation reaction of a divalent or more carboxylic acid (polyvalent carboxylic acid) with a divalent or more alcohols (polyhydric alcohol). The specific amorphous polyester resin is not particularly limited, and conventionally known amorphous polyester resins in the present art may be used.

The specific production method of the amorphous polyester resin is not limited, and the resin may be produced by polycondensation (esterification) of a polyvalent carboxylic acid and a polyhydric alcohol using a known esterification catalyst.

The weight average molecular weight (Mw) of the amorphous polyester resin is not particularly limited, but for example, it is preferable to be in the range of 5,000 to 100,000, and more preferably in the range of 5,000 to 50,000. When the above weight average molecular weight (Mw) is 5,000 or more, the heat-resistant storage property of the toner may be improved. When the weight average molecular weight (Mw) is 100,000 or less, it may further improve the low-temperature fixability of the toner.

Examples of the polyvalent carboxylic acid and the polyhydric alcohol used in the preparation of the amorphous polyester resin are not particularly limited, and examples thereof include the following.

### <<Polyvalent Carboxylic Acid>>

Examples of the polyvalent carboxylic acid include aromatic carboxylic acids such as terephthalic acid, isophthalic acid, phthalic anhydride, trimellitic anhydride, pyromellitic acid, and naphthalene dicarboxylic acid; aliphatic carboxylic acids such as maleic anhydride, fumaric acid, succinic acid, alkenyl succinic anhydride, and adipic acid; and alicyclic carboxylic acids such as cyclohexanedicarboxylic acid. These polyvalent carboxylic acids may be used alone, or two or more may be used in combination.

Among these polyvalent carboxylic acids, it is preferable to use aromatic carboxylic acids, and it is also preferable to use trivalent or higher carboxylic acids (such as trimellitic acid and its acid anhydride) together with dicarboxylic acids to form a cross-linked or branched structure to ensure better fixability.

Examples of the trivalent or higher carboxylic acids include 1,2,3-benzenetricarboxylic acid, 1,2,4-benzenetricarboxylic acid, 1,3,5-benzenetricarboxylic acid, 1,2,4-naphthalenetricarboxylic acid, and their anhydrides and lower alkyl esters. These may be used alone, or two or more may be used in combination.

### <<Polyhydric Alcohol>>

Examples of the polyhydric alcohol include aliphatic diols such as ethylene glycol, diethylene glycol, triethylene glycol, propylene glycol, butanediol, hexanediol, neopentyl glycol, and glycerin; alicyclic diols such as cyclohexanediol, cyclohexanedimethanol, and hydrogenated bisphenol A; and aromatic diols such as ethylene oxide adducts of bisphenol A and propylene oxide adducts of bisphenol A. These polyhydric alcohols may be used alone, or two or more may be used in combination.

Among these polyhydric alcohols, aromatic diols and alicyclic diols are preferred, and among these, aromatic diols are more preferred. In order to ensure better fixability, polyhydric alcohols of trivalent or higher value (glycerin, trimethylolpropane, pentaerythritol) may be used together with diols to form a cross-linked or branched structure.

The acid number of the polyester resin may be adjusted by further adding a monocarboxylic acid and/or monoalcohol to the polyester resin obtained by polycondensation of a polyvalent carboxylic acid and a polyhydric alcohol to esterify the hydroxy and/or carboxy groups at the polymerization end.

Examples of the monocarboxylic acid include acetic acid, acetic anhydride, benzoic acid, trichloroacetic acid, trifluoroacetic acid, and propionic anhydride. Examples of the monoalcohol include methanol, ethanol, propanol, octanol, 2-ethylhexanol, trifluoroethanol, trichloroethanol, hexafluoroisopropanol, and phenol.

As an amorphous polyester resin used in the present invention, it may be used a hybrid amorphous polyester resin in which a vinyl-based polymer segment composed of a styrene-acrylic polymer and a polyester-based polymer segment composed of an amorphous polyester resin are bonded via a bi-reactive monomer.

The content ratio of the vinyl polymer segment is preferably in the range of 5 to 30 mass %, and more preferably in the range of 10 to 20 mass %, relative to the total mass of the hybrid amorphous polyester resin.

When the hybrid amorphous polyester resin contains the vinyl polymer segment in the range of 5 to 30 mass %, it is possible to control the balance between charge retention and charge leakage.

### <Crystalline Resin>

### (Crystalline Polyester Resin)

It is preferable for the toner base particles of the present invention to contain a crystalline resin as a binder resin, from the viewpoint of low-temperature fixing properties.

A crystalline resin is a resin that has a clear endothermic peak in differential scanning calorimetry (DSC), rather than a staircase-like endothermic change. A clear endothermic peak means, specifically, a peak having a half value width of the endothermic peak within 15° C. when measured at a temperature rise rate of 10° C./min in differential scanning calorimetry (DSC).

As for the crystalline resin, there are no particular restrictions as long as it has the above characteristics, and any conventional crystalline resin known in the art may be used. Specific examples thereof include a crystalline polyester resin, a crystalline polyurethane resin, a crystalline polyurea resin, a crystalline polyamide resin, and a crystalline polyether resin. The crystalline resins may be used alone or in combination of two or more.

Among them, it is preferable that the crystalline resin is a crystalline polyester resin. Here, a “crystalline polyester resin” refers to a known polyester resin obtained by polycondensation reaction of a divalent or higher carboxylic acid (polyvalent carboxylic acid) and its derivatives with a divalent or higher alcohol (polyhydric alcohol) and its derivatives. The resin satisfies the above heat absorption characteristics.

The melting point of the crystalline polyester resin is preferably in the range of 55 to 90° C., and more preferably in the range of 60 to 85° C. When the melting point of the crystalline polyester resin is in the above range, sufficient low-temperature fixability and excellent image preservation property may be obtained. The melting point of the crystalline polyester resin may be controlled by the resin composition. The melting point of the crystalline polyester resin is the peak top temperature of the melting peak in the second temperature rise process in the DSC curve obtained by differential scanning calorimetry of the crystalline polyester resin alone as described above. If there are multiple melting peaks in the DSC curve, the peak top temperature of the melting peak with the highest endothermic value is used as a melting point.

The polyvalent carboxylic acid component for forming crystalline polyester resin is a compound that contains two or more carboxy groups in one molecule. Specifically, for example, saturated aliphatic dicarboxylic acids such as succinic acid, sebacic acid, and dodecanedioic acid; alicyclic dicarboxylic acids such as cyclohexanedicarboxylic acid; aromatic dicarboxylic acids such as phthalic acid, isophthalic acid, and terephthalic acid; trivalent or higher polyvalent carboxylic acids such as trimellitic acid and pyromellitic acid; and anhydrides or alkyl esters of these carboxylic acid compounds with one to three carbon atoms. It is preferable to use saturated aliphatic dicarboxylic acids as a polyvalent carboxylic acid component to form a crystalline polyester resin. These may be used alone, or two or more may be used in combination.

The polyhydric alcohol component for forming a crystalline polyester resin is a compound that contains two or more hydroxy groups in one molecule. Specific examples thereon include aliphatic diols such as ethylene glycol, 1,2-propanediol, 1,3-propanediol 1,4-butanediol, 1,5-pentanediol, 1,6-hexanediol, 1,7-heptanediol, 1,8-octanediol, neopentyl glycol, and 1,4-butenediol; and trivalent or higher polyhydric alcohols such as glycerin, pentaerythritol, trimethylolpropane, and sorbitol.

As a polyhydric alcohol component for forming the crystalline polyester resin, it is preferable to use an aliphatic diol. These may be used alone, and may be used in combination of two or more.

There are no particular restrictions on the production method of crystalline polyester resin, and it may be produced using the general polyester polymerization method in which the above-mentioned polyvalent carboxylic acids and polyhydric alcohols are reacted under a catalyst. For example, direct polycondensation method and ester exchange method are preferably used depending on the type of monomer.

The linear aliphatic hydroxycarboxylic acid may be used in combination with the polyvalent carboxylic acid and/or the polyhydric alcohol mentioned above. Examples of the linear aliphatic hydroxycarboxylic acid for forming crystalline polyester resins include 5-hydroxypentanoic acid, 6-hydroxyhexanoic acid, 7-hydroxypentanoic acid, 8-hydroxyoctanoic acid, 9-hydroxynonanoic acid, 10-hydroxydecanoic acid, 12-hydroxydodecanoic acid, 14-hydroxytetradecanoic acid, 16-hydroxyhexadecanoic acid, and 18-hydroxyoctadecanoic acid; and lactone compounds in which these hydroxycarboxylic acids are cyclized and alkyl esters of alcohols with one to three carbon atoms. These may be used alone, or two or more may be used in combination.

The use of polyvalent carboxylic acid and polyhydric alcohol component in the formation of crystalline polyester resin is also desirable because it makes it easier to control the reaction and obtain a resin with the desired molecular weight.

The catalyst that may be used in the production of crystalline polyester resins include titanium catalysts such as titanium tetraethoxide, titanium tetrapropoxide, titanium tetraisopropoxide, and titanium tetrabutoxide; and tin catalysts such as dibutyltin dichloride, dibutyltin oxide, and diphenyltin oxide.

The ratio of the polyvalent carboxylic acid component to the polyvalent alcohol component above is determined by the equivalent ratio of the hydroxy group [OH] of the polyvalent alcohol component to the carboxy group [COOH] of the polyvalent carboxylic acid component. The ratio of [OH]/[COOH] is preferably 1.5/1 to 1/1.5. 5, and more preferably in the range of 1.2/1 to 1/1.2.

The crystalline polyester resin preferably has an acid number in the range of 5 to 30 mg KOH/g, more preferably 10 to 25 mg KOH/g, and still more preferably in the range of 15 to 25 mg KOH/g. The acid number is the mass of potassium hydroxide (KOH) required to neutralize the acid contained in 1 g of the sample, expressed in mg. The acid number of the resin is calculated by the following procedure in accordance with JIS K0070-1992.

### (Preparation of Reagent)

1.0 g of phenolphthalein is dissolved in 90 mL of ethyl alcohol (95% by volume), then, ion-exchanged water is added to make 100 mL to prepare a phenolphthalein solution. 7 g of JIS special grade potassium hydroxide is dissolved in 5 mL of ion-exchanged water, and ethyl alcohol (95% by volume) is added to make 1 liter. The solution is left in an alkali-resistant container for 3 days to prevent exposure to carbon dioxide gas, and then filtered to prepare a potassium hydroxide solution. The standardization follows the description in accordance with JIS K0070-1992.

### (Main Test)

2.0 g of the crushed sample is weighted in a 200 mL Erlenmeyer flask, 100 mL of a mixed solution of toluene and ethanol (toluene:ethanol having a volume ratio 2:1) is added and the mixture is dissolve for 5 hours. Then, a few drops of phenolphthalein solution is added as an indicator, and titration is done with the prepared potassium hydroxide solution. The end point of the titration is the moment when the light red color of the indicator lasts for about 30 seconds.

### (Blank Test)

The same operation as in the main test is performed except that no sample is used (that is, only a mixed solution of toluene and ethanol (toluene:ethanol having a volume ratio of 2:1)).

The acid value is calculated by substituting the titration results of the main test and the blank test into the following Expression (a).

A=[(C−B)×f×5.6]/S Expression (a):

A: Acid value (mg KOH/g)

B: Amount of potassium hydroxide solution added during the blank test (mL)

C: Amount of potassium hydroxide solution added at the time of the main test (mL)

f: Factor of 0.1 mol/L potassium hydroxide ethanol solution.

S: Mass of the sample (g)

The weight average molecular weight (Mw) of the crystalline polyester resin is preferably in the range of 3,000 to 100,000 from the viewpoint of ensuring both sufficient low-temperature fusing performance and excellent long-term heat-resistant storage stability. It is more preferable to be in the range of 4,000 to 50,000, and still more preferably to be in the range of 5,000 to 20,000. The ratio of the diol component to the dicarboxylic acid component is determined by the ratio of the equivalent amount of hydroxyl group [OH] of the diol component to the equivalent amount of carboxyl group [COOH] of the dicarboxylic acid component. The ratio of [OH]/[COOH] is preferably 1.5/1 to 1/1.5, and more preferably the ratio is 1.2/1 to 1/1.2.

The content ratio of the crystalline polyester resin in the binder resin is preferably in the range of 5 to 20 mass %, and more preferably in the range of 5 to 10 mass %. When the content ratio of the crystalline polyester resin in the binder resin is 5 mass % or more, sufficient low-temperature fixability may be obtained without fail. Also, by having a content ratio of crystalline polyester resin in the binder resin of 20 mass % or less, it is possible to reliably introduce the crystalline polyester resin into the toner in the production of the toner.

Further, as a crystalline polyester resin, a styrene-acrylic modified crystalline polyester resin in which a styrene-acrylic polymer segment and a crystalline polyester polymer segment are bonded may be used.

The term “styrene-acrylic modified crystalline polyester resin” refers to a resin composed of polyester molecules with a block copolymer structure, in which a styrene-acrylic copolymer molecular chain (styrene-acrylic polymer segment) is chemically bonded to a crystalline polyester molecular chain (crystalline polyester polymer segment).

The method of forming the crystalline polyester polymer segment is not particularly limited. The specific types of polyvalent carboxylic acids and polyhydric alcohols used in the formation of such polymer segments, as well as the polycondensation conditions of these monomers, are the same as those described above, therefore, the description of these are omitted here.

On the other hand, the styrene-acrylic polymer segment constituting the styrene-acrylic modified crystalline polyester resin is formed by addition polymerization of at least a styrene monomer and a (meth)acrylic ester monomer. The styrene monomer and (meth)acrylic ester monomer used are not particularly limited, but for example, one or more types selected from the following may be used.

### (1) Styrene Monomers

Styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene, and derivatives thereof.

### (2) (Meth)Acrylic Acid Ester Monomers

Methyl (meth)acrylate, ethyl (meth)acrylate, n-butyl (meth)acrylate, isopropyl (meth)acrylate, isobutyl (meth)acrylate, t-butyl (meth)acrylate, n-octyl (meth)acrylate, 2-ethylhexyl (meth)acrylate, n-stearyl (meth)acrylate, dodecyl (meth)acrylate, phenyl (meth)acrylate, diethylaminoethyl (meth)acrylate, dimethylaminoethyl (meth)acrylate, and derivatives thereof.

In this specification, the term “(meth)acrylic acid” includes both acrylic acid and methacrylic acid.

In addition to the monomers listed above, the styrene-acrylic polymer segment may be formed using the following additional monomers.

### (3) Vinyl Esters

Vinyl propionate, vinyl acetate, and vinyl benzoate.

### (4) Vinyl Ethers

Vinyl methyl ether and vinyl ethyl ether.

### (5) Vinyl Ketones

Vinyl methyl ketone, vinyl ethyl ketone, and vinyl hexyl ketone.

### (6) N-Vinyl Compounds

N-vinylcarbazole, N-vinylindole, and N-vinylpyrrolidone.

### (7) Other Monomers

Vinyl compounds such as vinyl naphthalene and vinyl pyridine, and acrylic acid or methacrylic acid derivatives such as acrylonitrile, methacrylonitrile, and acrylamide.

The method of producing styrene-acrylic polymer segment is not particularly limited. Examples of the method use any polymerization initiator such as peroxide, persulfide, persulfate, and azo compounds, which are normally used in the polymerization of the above monomers. Examples of the polymerization method include known polymerization methods such as bulk polymerization, solution polymerization, emulsion polymerization method, miniemulsion method and dispersion polymerization method.

The content ratio of the crystalline polyester polymer segment in the styrene-acrylic modified crystalline polyester resin is not particularly limited, but it is preferably in the range of 60 to 99 mass % relative to 100 mass % of the styrene-acrylic modified polyester resin. More preferably, it is in the range of 70 to 98 mass %.

The content ratio of the styrene acrylic polymer segment in the styrene-acrylic modified crystalline polyester resin (hereinafter referred to as a “styrene-acrylic modified amount”) is not particularly limited, but it is preferably in the range of 1 to 40 mass % of with respect to 100 mass % the styrene-acrylic modified crystalline polyester resin. More preferably, it is in the range of 2 to 30 mass %.

The styrene-acrylic modified amount is referred to the ratio of the total mass of the styrene monomer and the (meth)acrylic acid ester monomer with respect to the total mass of the resin material used for synthesizing the styrene-acrylic modified crystalline polyester resin. Here, the total mass of the resin material used for synthesizing the styrene-acrylic modified crystalline polyester resin means the total mass of: the monomer for synthesizing an unmodified crystalline polyester resin that becomes a crystalline polyester polymerized segment; the styrene monomer that becomes a styrene-acrylic polymer segment; and the bi-reactive monomer that combines these monomers with the (meth)acrylic acid ester monomer.

The “bi-reactive monomer” is a monomer that combines the styrene-acrylic polymer segment with the crystalline polyester polymer segment. This is a monomer having both a group selected from a hydroxy group, a carboxy group, an epoxy group, a primary amino group and a secondary amino group for forming a crystalline polyester polymer segment, and an ethylenically unsaturated group for forming a styrene-acrylic polymer segment in the molecule.

Examples of the bi-reactive monomer include acrylic acid, methacrylic acid, fumaric acid, and maleic acid. In addition, their hydroxyalkyl (1 to 3 carbon atoms) esters may be used, but acrylic acid, methacrylic acid, or fumaric acid is preferred from the viewpoint of reactivity. The styrene-acrylic polymer segment and the crystalline polyester polymer segment are bonded via the bi-reactive monomer.

From the viewpoint of improving the low-temperature fixability, the amount of the bi-reactive monomer used is preferably in the range of 1 to 2 mass % based on the total amount of monomers constituting the styrene-acrylic polymer segment as 100 mass %.

The production method of styrene-acrylate modified crystalline polyester resin is not particularly limited as long as the method is capable of forming a polymer with a structure in which a crystalline polyester polymer segment and a styrene-acrylate polymer segment are chemically bonded. Specific manufacturing methods for styrene-acrylic modified crystalline polyester resin include, for example, the following methods.

(A) A method in which a crystalline polyester polymer segment is polymerized in advance, and a bi-reactive monomer is reacted with the crystalline polyester polymer segment, further, by reacting a styrene monomer and a (meth)acrylic acid ester monomer for forming the styrene-acrylic polymerization segment, the styrene-acrylic polymer segment is formed.
(B) A method in which a styrene-acrylic polymer segment is polymerized in advance, then, a bi-reactive monomer is reacted with the styrene-acrylic polymer segment, further, by reacting with a polyvalent carboxylic acid and a polyhydric alcohol for forming a crystalline polyester polymerized segment, a crystalline polyester polymer segment is formed.
(C) A method in which a crystalline polyester polymer segment and the styrene-acrylic polymer segment are each respectively polymerized in advance, and a bi-reactive monomer is reacted with each of them to bond the two.

Among the above-described forming methods (A) to (C), the method (A) is preferable from the viewpoint of simplifying the production process.

### [2.2.2] Other Ingredients

### (Colorant)

As a colorant, carbon black, magnetic materials, dyes, and pigments may be arbitrarily used. As carbon black, channel black, furnace black, acetylene black, thermal black, or lamp black may be used. As a magnetic material, ferromagnetic metals such as iron, nickel, or cobalt, alloys containing these metals, or compounds of ferromagnetic metals such as ferrite and magnetite may be used.

Examples of the dye include C.I. Solvent Red 1, 49, 52, 58, 63, 111, 122; C.I. Solvent Yellow 19, 44, 77, 79, 81, 82, 93, 98, 103, 104, 112, 162; C.I. Solvent blue 25, 36, 60, 70, 93, 95; and a mixture thereof may also be used. Examples of the pigment include C.I. Pigment Red 5, 48: 1, 48: 3, 53: 1, 57: 1, 81: 4, 122, 139, 144, 149, 166, 177, 178, 222; C.I. Pigment Orange 31, 43; C.I. Pigment Yellow 14, 17, 74, 93, 94, 138, 155, 180, 185; C.I. Pigment Green 7; C.I. Pigment Blue 15: 3, 15: 4, 60, and mixtures thereof may also be used.

Examples of the colorant for white include inorganic pigments (e.g., titanium white, zinc white, titanium strontium white, heavy calcium carbonate, light calcium carbonate, titanium dioxide, aluminum hydroxide, satin white, talc, calcium sulfate, barium sulfate, zinc oxide, magnesium oxide, magnesium carbonate, amorphous silica, colloidal silica, white carbon, kaolin, calcined kaolin, delaminated kaolin, aluminosilicate, sericite, bentonite, and smectite), or organic pigments (e.g., polystyrene resin particles, and urea-formalin resin particles).

The content of the above-mentioned colorant in the toner base particle may be determined as appropriate and independently, for example, from the viewpoint of ensuring the color reproducibility of the image. It is preferable to be in the range of 1 to 30 mass %, and more preferably in the range of 2 to 20 mass %.

The size of the colorant particles is preferably within the range of 10 to 1,000 nm in volume average particle diameter. It is more preferably in the range of 50 to 500 nm, and still more preferably in the range of 80 to 300 inn.

The volume average particle diameter may be a catalog value. For example, the volume average particle diameter (median diameter on a volume basis) of a colorant may be measured by “UPA-1 50” (manufactured by MicrotracBEL Corp.).

### (Mold Release Agent)

The toner according to the present invention may contain a mold release agent (also called a “wax”). A variety of known waxes may be used as a mold release agent.

Examples of the mold release agent include polyolefin waxes such as polyethylene wax and polypropylene wax; branched chain hydrocarbon waxes such as microcrystalline wax; long chain hydrocarbon waxes such as paraffin wax, sazole wax, and Fischer-Tropsch wax; dialkyl ketone waxes such as distearyl ketone; ester waxes such as carnauba wax, montan wax, behenyl behenate, trimethylolpropane tribehenate, pentaerythritol tetrabehenate, pentaerythritol diacetate dibehenate, glycerin tribehenate, 1,18-octadecanediol distearate, tristearyl trimellitate, distearyl maleate, polyglycerol esters of fatty acids; and amide waxes such as ethylenediamine behenylamide, and tristearyl trimellitate.

As a mold release agent, it is preferable to use an agent that does not have an interaction such as compatibility with the resin constituting the binder resin.

Among these, from the viewpoint of mold release at low-temperature fixing, it is preferable to use one with a low melting point, specifically, one with a melting point in the range of 60 to 100° C. Further, as a mold release agent, it is preferable to use one having a melting point of about (Mp1−10) ° C. to (Mp1+20) ° C. with respect to the melting point Mp1 of the crystalline polyester resin constituting the binder resin.

The content ratio of the mold release agent is preferably in the range of 1 to 20 mass5 in the toner, and more preferably in the range of 5 to 20 mass %. By having the content ratio of the mold release agent in the toner in the above range, both separability and fixability may be obtained reliably.

As a method of introducing the mold release agent into the toner, in the aggregation and fusion steps of the toner manufacturing method described later, it may cited a method of aggregating and fusing particles composed of only a mold release agent together with amorphous resin particles and crystalline polyester resin particles in an aqueous medium. The mold release agent particles may be obtained as a dispersion liquid of the mold release agent in an aqueous medium. The dispersion liquid of the mold release agent particles may be prepared by heating an aqueous medium containing a surfactant to a temperature higher than the melting point of the mold release agent, adding a molten mold release agent solution, dispersing it finely by applying mechanical energy such as mechanical agitation or ultrasonic energy, and then cooling it.

When the amorphous resin is, for example, a styrene-acrylic resin, by mixing the mold release agent in advance with the amorphous resin particles (styrene-acrylic resin particles) used in the aggregation and fusion steps, the mold release agent may also be introduced into the toner.

Specifically, the mold release agent is dissolved in a solution of the polymerizable monomer to form styrene-acrylic resin. This solution is added to an aqueous medium containing a surfactant, and the solution is finely dispersed by applying mechanical energy such as mechanical stirring or ultrasonic energy in the same manner as described above, and then the polymerization is carried out at the desired polymerization temperature by adding a polymerization initiator. The dispersion of the amorphous resin particles containing the mold release agent may be prepared by the so-called mini-emulsion polymerization method.

### (Charge Control Agent)

A variety of known compounds may be used as charge control agents. Examples thereof include nigrosine dyes, metal salts of naphthenic acid or higher fatty acids, alkoxylated amines, quaternary ammonium salt compounds, azo metal complexes, and salicylic acid metal salts.

The content of the charge control agent in the toner of the present invention is usually in the range of 0.1 to 10 mass % with respect to 100 mass % of the binder resin. It is preferably in the range of 0.5 to 5 mass %.

The size of the particles of the charge control agent is in the range of, for example, 10 to 1,000 nm in number average primary particle diameter. It is preferably in the range of 50 to 500 inn, and more preferably in the range of 80 to 300 nn.

In the toner particles according to the present invention, it is preferable to have a core-shell structure that includes core particles containing a binder resin and a colorant, and a shell layer coated on the surface of the core particles. The shell layer is not limited to the one that completely covers the core particles, and the surface of the core particles may be partially exposed. The core-shell structure of the toner enables the toner to have charge stability and heat-resistant storage properties. The resin that constitutes the shell layer is not particularly limited, but it is preferable to use an amorphous polyester resin or an amorphous vinyl resin.

The core-shell structure may be confirmed by observing the cross-sectional structure of the toner using known means such as transmission electron microscopy (TEM) and scanning probe microscopy (SPM).

### [2.2.3] Method for Manufacturing Toner Particles

The method of manufacturing the toner particles of the present invention is not limited to any particular method. Examples thereof includes known methods such as a kneading and a pulverizing method, a suspension polymerization method, a emulsion aggregation method, a dissolution and suspension method, a polyester elongation method, and a dispersion polymerization method. Among these, the emulsion aggregation method is preferable in terms of uniformity of particle size, and controllability of shape.

The toner particles according to the present invention may be manufactured by a manufacturing method that specifically includes the following steps. However, only one example is disclosed here, and the present invention is not limited to the following example of manufacturing methods.

The toner particles of the present invention are preferably produced by a wet process, which is made in an aqueous medium, for example, by the emulsion aggregation method.

In the emulsion aggregation method, the aqueous dispersion liquid of resin particles constituting the binder resin is mixed with the aqueous dispersion liquid of particles of other toner components as necessary, and the particles are slowly aggregated while maintaining a balance between the repulsive force on the particle surface due to pH adjustment and the aggregation force due to the addition of a coagulant made of an electrolyte. At the same time, the particles are fused together by heating and stirring to control the shape of the particles.

As a preferable method for producing the toner particles according to the present invention, an example of obtaining toner particles having a core-shell structure by using an emulsion aggregation method is shown below.

(1) The process of preparing a dispersion liquid of colorant particles in which white colorant particles are dispersed in an aqueous medium
(2) The process of preparing a resin particle dispersion liquid (core-shell resin particle dispersion liquid) in which binder resin particles containing an internal additive are dispersed in an aqueous medium, if necessary
(3) The process of mixing the colorant particle dispersion liquid and the core resin particle dispersion liquid to obtain an aggregating resin particle dispersion liquid, and the colorant particles and the binder resin particles are aggregated and fused in the presence of the coagulant to obtain the core particles (aggregation-fusion process)
(4) The process of adding the shell resin particle dispersion liquid containing shell binder resin particles is added to the dispersion liquid containing core particles to aggregate and fuse the shell particles on the surface of the core particles to form a toner having a core-shell structure (aggregation-fusion process)
(5) The process of filtering the toner base particles from the dispersion liquid of toner base particles (toner base particle dispersion liquid) to remove surfactants (filtering and cleaning process)
(6) The process of drying toner base particles (drying process)
(7) The process of adding an external additive to the toner base particles (external additive treatment process) The toner particles having a core-shell structure, are obtained as follows. First, the binder resin particles for the core particles and the colorant particles are aggregated and fused to prepare the core particles. Next, the binder resin particles for the shell are added to the dispersion liquid of the core particles, and the binder resin particles for the shell are aggregated and fused on the surface of the core particles to form a shell layer covering the surface of the core particles. However, for example, in the above process (4), toner particles formed from single-layer particles may be similarly produced without adding the shell resin particle dispersion liquid.

In the present invention, an “aqueous medium” refers to a medium containing 50 to 100 mass % of water and 0 to 5 mass % of a water-soluble organic solvent. Examples of water-soluble organic solvents include methanol, ethanol, isopropanol, butanol, acetone, methyl ethyl ketone, and tetrahydrofuran, and it is preferable to use an alcohol-based organic solvent that does not dissolve the resulting resin.

(1) Colorant particle dispersion liquid preparation process

The colorant particle dispersion liquid may be prepared by dispersing the colorant in an aqueous medium. The dispersion process of the colorant is preferably carried out in an aqueous medium with the surfactant having a concentration at or above the critical micelle concentration (CMC), since the colorant is uniformly dispersed. A variety of well-known dispersing devices may be used for the dispersion process of the colorant.

### (Surfactant)

Example of the surfactant include anionic surfactants such as alkyl sulfate ester salt, polyoxyethylene (n)alkyl ether sulfates, alkylbenzene sulfonate, a-olefin sulfonate, and phosphate ester; amine salt types such as alkylamine salt, aminoalcohol fatty acid derivative, polyamine fatty acid derivative, and imidazoline; quaternary ammonium salt type cationic surfactants such as alkyltrimethylammonium salt, dialkyldimethylammonium salt, alkyldimethylbenzylammonium salt, pyridinium salt, alkylisoquinolinium salt, benzethonium chloride; nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaine. Anionic and cationic surfactants with a fluoroalkyl group may also be used.

The dispersion diameter of the colorant particles in the colorant particle dispersion liquid prepared in this colorant particle dispersion liquid preparation process is preferably in the range of 10 to 300 nm in terms of median diameter on a volume basis. The volume-based median diameter of the colorant particles in the colorant particle dispersion liquid is measured using an electrophoretic light scattering spectrophotometer “ELS-80 0 (manufactured by Otsuka Electronics Co., Ltd.)”.

The colorant may be introduced into the toner by dissolving or dispersing it in the monomer solution for forming the amorphous resin in advance using the mini-emulsion method in the amorphous resin particle dispersion preparation process described below.

(2) The process of preparing a resin particle dispersion liquid (resin particle dispersion liquid for core/shell) in which the binder resin particles are dispersed in an aqueous medium, containing an internal additive as necessary

Examples of the method of dispersing the binder resin in an aqueous medium includes an aqueous direct dispersion method, in which the binder resin is dispersed in an aqueous medium to which a surfactant is added by ultrasonic dispersion or bead mill dispersion, a dissolution emulsion desolvation method, in which the binder resin is dissolved in a solvent and dispersed in an aqueous medium to form emulsified particles (oil droplets), and then the solvent is removed, and an inverted-phase emulsification method.

The average particle diameter of the binder resin particles obtained in this process of preparing a dispersion of binder resin particles is preferably in the range of 50 to 500 nm in terms of median diameter on a volume basis, for example. The median diameter on a volume basis may be calculated using the UPA-EX15 0” (manufactured by MicrotracBEL Corp.).

When the binder resin is an amorphous vinyl resin, it is possible to prepare a dispersion liquid of amorphous resin particles as follows. In an aqueous medium containing a surfactant below the critical micelle concentration (CMC), a liquid in which toner constituents such as a mold release agent and a charge control agent are dissolved or dispersed is added to the polymerizable monomer for forming an amorphous vinyl resin, if necessary. Then mechanical energy is applied to form the droplets, then a water-soluble radical polymerization initiator is added to allow the polymerization reaction to proceed in the droplets. An oil-soluble polymerization initiator may be included in the aforementioned droplet. In the process of preparing the amorphous resin particle dispersion liquid, the process of emulsifying (droplet formation) by applying mechanical energy is essential. The means of imparting such mechanical energy may include strong agitation or ultrasonic vibration energy imparting means such as a homomixer, an ultrasonic mixer, and a Manton-Gaulin mixer.

The binder resin particles formed in this binder resin particle dispersion liquid preparation process may be composed of two or more layers made of resins having different compositions. In this case, a polymerization initiator and a polymerizable monomer are added to the dispersion liquid of resin particles prepared by an emulsion polymerization treatment (first stage polymerization) according to a conventional method. Then, a method of polymerizing this system (second stage polymerization and third stage polymerization) may be adopted.

When a surfactant is used in this process, the surfactant may be the same as the surfactant described above, for example.

### (Polymerization Initiator)

As a polymerization initiator used, various known polymerization initiators may be used. Specific examples thereof include peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetraline hydroperoxide, 1-phenyl-2-methylpropyl-1-hydroperoxide, pertriphenylacetic acid-tert-hydroperoxide, performic acid-tert-butyl, peracetic acid-tert-butyl, perbenzoic acid-tert-butyl, perphenylacetic acid-tert-butyl, permethoxyacetic acid-tert-butyl, per-N-(3-toluyl) palmitate-tert-butyl; and azo compounds such as 2,2′-azobis(2-amidinopropane) hydrochloride, 2,2′-azobis-(2-amidinopropane) nitrate, 1,1′-azobis(1-methylbutyronitrile)-3-sulfonate, 4,4′-azobis-4-cyanovaleric acid, and poly(tetraethyleneglycol-2,2′-azobisisobutyrate). Among these, water-soluble polymerization initiators such as ammonium persulfate, sodium persulfate, potassium persulfate, hydrogen peroxide, 2,2′-azobis(2-amidinopropane) hydrochloride, 2,2′-azobis-(2-amidinopropane) nitrate, 1,1′-azobis (1-methylbutyronitrile-3-sulphonate sodium), and 4,4′-azobis-4-cyanovaleric acid may be used preferably.

Redox polymerization initiators such as persulfate and metabisulfite or hydrogen peroxide and ascorbic acid may also be used as polymerization initiators.

### (Chain Transfer Agent)

In the process of preparing a dispersion liquid of binder resin (especially amorphous vinyl resin) particles, a commonly used chain transfer agent may be used for the purpose of adjusting the molecular weight of the amorphous resin. The chain transfer agents are not particularly limited, and include, for example, alkyl mercaptans and mercapto fatty acid esters.

The average particle diameter of the amorphous vinyl resin particles obtained in this process of preparing a dispersion liquid of the binder resin particles is preferably in the range of, for example, 50 to 500 nm in terms of median diameter on a volume basis. The median diameter on a volume basis is calculated by using the “UPA-EX150” (manufactured by MicrotracBEL Corp.).

(3) The process of mixing the colorant particle dispersion liquid and the resin particle dispersion liquid for the core to obtain the resin particle dispersion liquid for aggregation, and the colorant particles and the binder resin particles are aggregated and fused to form aggregated particles as core particles in the presence of a coagulant (aggregation and fusion process)

In this process, the colorant particles and the binder resin particles contained in the dispersion liquid formed in the above step process are aggregated and fused in an aqueous medium.

Specific methods for aggregating and fusing the colorant particle dispersion and the binder resin particle dispersion include the following method. A coagulant is added to the aqueous medium so that the concentration is equal to or higher than the critical coagulation concentration, and then the mixture is heated to a temperature equal to or higher than the glass transition point of the binder resin particles and equal to or higher than the melting peak temperature of the mold release agent. As a result, the salting out of the colorant particles and the binder resin particles is promoted, and at the same time, the fusion is promoted in parallel. When the particles have grown to the desired particle size, an aggregation terminator is added to stop the particle growth, and if necessary, heating is continued to control the particle shape.

In this method, it is preferable to shorten the time left after adding the coagulant as much as possible and promptly heat it to a temperature higher than the glass transition point of the sintering resin. The reason for this is not clear, but it is because there is a concern that depending on the time left after salt precipitation, the aggregation state of the particles may fluctuate, causing the particle size distribution to become unstable or the surface properties of the fused particles to fluctuate. The time required to raise the temperature is usually 30 minutes or less, and 10 minutes or less is more preferable.

The temperature rise rate is preferably 1° C./min or higher. The upper limit of the temperature increase rate is not specifically defined, but from the viewpoint of suppressing the generation of coarse particles due to rapid fusion, it is preferable to keep the rate below 15° C./min. Furthermore, after the reaction system reaches a temperature higher than the glass transition point, it is essential to maintain the temperature of the reaction system for a certain period of time to continue the fusion process. This allows the growth of the toner and the fusion to proceed effectively, thereby improving the durability of the toner that is ultimately obtained.

### (Coagulant)

The coagulant to be used is not particularly limited, but one selected from metal salts is preferably used. Examples thereof include monovalent metal salts of salts of alkali metals such as sodium, potassium and lithium; divalent metal salts such as calcium, magnesium, manganese and copper; trivalent metal salts such as iron and aluminum. Specific metal salts include sodium chloride, potassium chloride, lithium chloride, calcium chloride, magnesium chloride, zinc chloride, copper sulfate, magnesium sulfate, and manganese sulfate. Among these, it is particularly preferable to use divalent metal salts because they can promote aggregation with a small amount and aggregation may be easily controlled. These may be used alone or in combination of two or more.

When a surfactant is used in this process, for example, the same surfactant as described above may be used as a surfactant.

(4) The process of forming toner base particles with a core-shell structure by adding a dispersion liquid of resin particles for shells containing binder resin particles for shells to a dispersion liquid containing core particles to aggregate and fuse the particles for shells onto the surface of the core particles (aggregation and fusing process)

This step is similar to the process (aggregation-fusing step) of (3) in which the colorant particles and the binder resin particles are aggregated and fused to form aggregated particles as core particles. Shell particles are aggregated and fused on the surface of the core particles to form toner base particles having a core-shell structure.

(5) The process of filtering out the toner base particles from the dispersion liquid of toner base particle (toner base particle dispersion liquid) and removing the surfactant (filtering and cleaning process)
(6) The process of drying toner base particles (drying process)

The filtering, cleaning, and drying processes may be carried out by employing various known methods.

(7) The process of adding an external additive to the toner base particles (external additive treatment process)

This external additive treatment process is a process of adding and mixing the external additive according to the present invention to the dried and treated toner base particles.

Examples of the method for adding the external additive include a dry method in which a powdery external additive is added to the dried toner base particles and mixed, and the mixing device is a mechanical type such as a Henschel mixer or a coffee mill.

### [2.2.4] Physical Properties of Toner Particles

### <Average Particle Diameter of Toner Particles>

The average particle diameter of the toner particles of the present invention is preferably in the range of 3 to 8 μm in terms of median diameter on a volume basis, and more preferably it is in the range of 5 to 8 μm.

This average particle diameter may be controlled by the concentration of the coagulant used, the amount of organic solvent added, the fusion time, and the composition of the polymer, for example, when the emulsion aggregation method described below is employed to manufacture the product. By having the median diameter on a volume basis in the above range, the transfer efficiency is increased and the halftone image quality is improved, and the image quality of fine lines and dots is enhanced.

The toner volume-based median diameter may be measured, for example, using a measuring device Multisizer 3″ (manufactured by Beckman Coulter Corporation) that is connected to a computer system equipped with data processing software “Software V 3.51”.

Specifically, 0.02 g of the measurement sample (toner) is added to 20 mL of surfactant solution (a surfactant solution made by diluting neutral detergent containing surfactant ingredients 10 times with pure water, for example, for the purpose of toner dispersion). After performing ultrasonic dispersion for 1 minute, the toner dispersion is placed in a beaker containing ISOTONII (manufactured by Beckman Coulter Corporation) in a sample stand until the concentration displayed on the measurement device reaches 8%. By using this concentration range, reproducible measurement values may be obtained. In the measurement system, the number of particles counted is set to 25,000, the aperture diameter is set to 10 μm. The frequency value is calculated by dividing the measurement range of 2 to 60 μm into 256 parts, and the particle diameter of the 50% from the larger volume integrated fraction is considered to be the median diameter based on volume.

### <Average Circularity of Toner Particles>

With respect to the toner particles of the present invention, it is preferable that the average circularity thereof is in the range of 0.930 to 1.00, from the viewpoint of stability of charging characteristics and low-temperature fixability. It is more preferable that the average circularity is in the range of 0.950 to 0.995. When the average circularity is within the above range, individual toner particles are less likely to be crushed, thereby preventing contamination of the frictional charging member, stabilizing chargeability of the toner, and resulting in high image quality in the formed image.

In the present invention, the average circularity of toner particles is measured using the “FPIA-3000” (manufactured by Sysmex Corporation).

Specifically, the sample (toner particles) is blended with an aqueous solution containing a surfactant and dispersed by ultrasonic dispersion for 1 minute. Then the sample is measured by “FPIA-3000” (Sysmex Corporation). In the HPF (high magnification imaging) mode, an image is taken with an appropriate concentration of 3,000 to 1,000 HPF detections. The circularity of each toner particle is calculated according to the following Expression (T), and then the circularity of each toner particle is added and divided by the total number of toner particles to obtain an average circularity.

Circularity=(Perimeter of the circle with the same projected area as the particle image)/(Perimeter of the particle projection image) Expression (T):

### <Softening Point of Toner Particles>

The softening point of the toner particles is preferably in the range of 80 to 120° C. from the viewpoint of obtaining low-temperature fixability for the toner, and more preferably it is in the range 90 to 110° C.

The softening point of toner particles is measured by the flow tester shown below.

Specifically, first, 1.1 g of the sample (toner) is placed in a petri dish, flattened and left for at least 12 hours under an environment of 20° C. and 50% RH. The sample is molded with the molding machine “SSP-10A” (manufactured by Shimadzu Corporation). A cylindrical sample with a diameter of 1 cm is prepared by pressurizing the sample with a force of 3,820 kg/cm² for 30 seconds. Then, the molded sample is subjected to a flow tester CFT-500D ((manufactured by Shimadzu Corporation) at 24° C. and 50% RH under the following conditions: load of 196 N (20 kgf), starting temperature of 60° C., preheating time of 300 seconds, and temperature rise rate of 6° C./min. Under these conditions, the melt is extruded from the hole of the cylindrical die (1 mm diameter×1 mm) using a piston with a diameter of 1 cm from the end of preheating time. The offset method temperature T_{offset} measured by the melting temperature measuring method of the temperature raising method with the offset value set to 5 mm is defined as a softening point.

### [3] Electrophotographic Image Forming Method and Electrophotographic Image Forming Apparatus

The electrophotographic image forming method of the present invention is an electrophotographic image formation method comprising at least an image carrier charging step, an electrostatic charge image forming step, an electrostatic charge image developing step, a toner image transfer step, a toner image fixing step, and a cleaning step. The method is characterized in that it uses at least the two-component developer for electrostatic charge image development of the present invention.

Specifically, the method contains the following steps: a charging step of charging the surface of the image carrier, an electrostatic charge image forming step of forming an electrostatic charge image on the surface of the charged image carrier, a developing step of developing an electrostatic charge image formed on the surface of the image carrier as a toner image using at least four colors of the two-component developer for electrostatic charge image development of the present invention, a transfer step of transferring the toner image formed on the surface of the image carrier to the surface of the recording medium, a fixing step of fixing the toner image transferred to the surface of the recording medium, and a cleaning step of cleaning the surface of the image carrier.

### (Charging Step)

In this process, the electrophotographic photoreceptor is charged. The method of charging the electrophotographic photoreceptor is not particularly limited. For example, a known method such as a charging roller method, in which the electrophotographic photoreceptor is charged by a charging roller, may be used.

### (Electrostatic Charge Image Forming Step)

In this step, an electrostatic charge image is formed on the electrophotographic photoreceptor (electrostatic charge image carrier).

Electrophotographic photoreceptors are not particularly limited, but include, for example, drum-shaped materials made of organic photoreceptors such as polysilane or phthalopolymethine are cited.

The formation of an electrostatic charge image is performed, for example, by uniformly charging the surface of the electrophotographic photoreceptor with a charging unit and exposing the surface of the electrophotographic photoreceptor to an image by an exposure unit. The electrostatic charge image is an image formed on the surface of the electrophotographic photoreceptor by such a charging unit.

The charging unit and exposure unit are not limited, and those commonly used in electrophotographic methods may be used.

### (Developing Step)

The developing step is a step of developing an electrostatic charge image with a toner (generally, a dry developer containing a toner) to form a toner image.

Toner image formation is performed, for example, with a dry developer containing a toner, using a developing unit composed of an agitator that charges the toner by frictional agitation and a rotatable magnetic roller.

Specifically, in the developing unit, for example, the toner and the carrier are mixed and stirred, and the toner is charged by the friction during the mixing and stirring, and is held on the surface of the rotating magnetic roller to form a magnetic brush. Since the magnetic roller is located near the electrophotographic photoreceptor, some of the toner that makes up the magnetic brush formed on the surface of the magnetic roller moves to the surface of the electrophotographic photoreceptor due to electrical attraction. As a result, the electrostatic charge image is developed by the toner and a toner image is formed on the surface of the electrophotographic photoreceptor.

### (Transfer Step)

In this step, the toner image is transferred to the recording medium.

The transfer of the toner image to the recording medium is done by peeling and charging the toner image onto the recording medium.

As a transfer unit, for example, a corona transfer device by corona discharge, a transfer belt, or a transfer roller may be used.

Further, in the transfer step, for example, the following embodiment may be used. In this embodiment, an intermediate transfer body is used, and a toner image is first transferred onto the intermediate transfer body, and then the toner image is secondarily transferred onto a recording medium. The transfer step may also be performed by directly transferring the toner image formed on the electrophotographic photoreceptor to a recording medium.

### (Fixing Step)

In the fixing step according to the present invention, it has a step of fixing an toner image to a recording material by passing a recording material to which an unfixed image (toner image) formed by using the toner is transferred between a heated fixing belt or fixing roller and a pressure member, thus, the unfixed image is transferred. When the fixing belt or the fixing roller used is the fixing member according to the present invention, the paper output speed of the image forming apparatus is increased to a high speed (copy speed of 70 cpm or more, so-called Seg. 5 or higher), the effect of high fixing separation performance and no image irregularity may be obtained.

Specific examples of the method for the fixing step include a belt fixing method and a roller fixing method. For example, it is composed of a fixing belt or a fixing roller as a fixing rotating body and a pressure roller as a pressure member provided in a state of being pressure-welded so as to form a fixing nip portion on the fixing belt or the fixing roller.

### (Cleaning Step)

In this step, the developer that has not been used for image formation or remains untransferred on the developer carrier such as the photoreceptor and the intermediate transfer body is removed from the developer carrier.

Although the cleaning method is not limited, it is preferable to use a method in which a blade is provided with its tip in contact with the photoreceptor or other cleaning target, and which rubs the surface of the photoreceptor.

In the electrophotographic image forming method of the present invention, the image of the colored or black toner is eventually transferred to and formed on the recording medium.

The recording medium is not particularly limited. Examples thereof include plain paper from thin paper to thick paper, coated printing paper such as high-quality paper, art paper or coated paper, and commercially available paper such as Japanese paper and postcard paper; resin films such as polypropylene (PP) film, polyethylene terephthalate (PET) film, triacetyl cellulose (TAC) film; and cloth. The recording medium for the present invention is not limited to these. Further, the color of the recording medium is not particularly limited, and recording media of various colors may be used.

In addition, the electrophotographic image forming apparatus of the present invention is an electrophotographic image forming apparatus that is at least equipped with an image carrier charging unit, an electrostatic charge image forming unit, an electrostatic charge image developing unit, a toner image transferring unit, a toner image fixing unit, and a cleaning unit. It is characterized in that it uses the two-component developer for electrostatic charge image development of the present invention.

Specifically, the image forming apparatus contains the following: an image carrier, a charging unit for charging the surface of the image carrier, a static charge image forming unit for forming a static charge image on the surface of the charged image carrier, a developing unit for developing an electrostatic charge image formed on the surface of the image carrier as a toner image using the toner set for development of the electrostatic image of the present invention, a transfer unit for transferring the toner image formed on the surface of the image carrier to the surface of the recording medium, a fixing unit for fixing the toner image transferred to the surface of the recording medium, and a cleaning unit for cleaning the surface of the image carrier.

As an electrophotographic image forming apparatus of the present invention, for example, an image forming apparatus as shown in the FIGURE may be used. The FIGURE is a cross-sectional schematic diagram showing a configuration in one example thereof. The image forming apparatus 100 is called a tandem color image forming apparatus. It has four sets of image forming sections (image forming units) 10Y, 10M, 10C and 10 Bk arranged vertically in rows, an intermediate transfer unit 7, paper feeding unit 21 and fixing unit 24. A document image reader SC is arranged at the upper part of the main body A of the image forming apparatus 100.

The intermediate transfer body unit 7 includes an endless belt-shaped intermediate transfer body 70 that may be rotated windingly by rollers 71, 72, 73, and 74, a primary transfer rollers 5Y, 5M, 5C, 5Bk, and a cleaning unit 6b.

The four sets of image forming units 10Y, 10M, 10C and 10Bk each have a drum-shaped photoreceptor 1Y, 1M, 1C and 1Bk at the center, and a charging unit 2Y, 2M, 2C and 10Bk arranged around the drum-shaped photoreceptors 1Y, 1M, 1C and 1Bk, respectively, and further have an exposure unit 3Y, 3M, 3C and 3Bk, a rotating developing unit 4Y, 4M, 4C and 4Bk, and a cleaning unit 6Y, 6M, 6C and 6Bk for cleaning the photoreceptors 1Y, 1M, 1C and 1Bk. The image forming apparatus 100 is equipped with photoreceptors 1Y, 1M, 1C and 1Bk as photoreceptors according to the present invention.

Image forming units 10Y, 10M, 10C and 10Bk form toner images of yellow, magenta, cyan, and black colors, respectively. In the image forming system of the present invention, the charging step, the exposure step and the development step are the steps for forming a toner image on a photoreceptor. In the image forming apparatus 100, the image formation is made in the image forming units 10Y, 10M, 10C, and 10Bk by using the photoreceptors 1Y, 1M, 1C and 1Bk, and the toner according to the present invention. The toner may be mixed with the carrier as described above and to be used as a two-component developer.

The image forming units 10Y, 10M, 10C, and 10Bk have the same configuration except for the color of the toner image formed on the photoreceptors 1Y, 1M, 1C, and 1Bk, respectively. Therefore, the image forming unit 10Y will be described in detail as an example.

The image forming unit 10Y arranges a charging unit 2Y, an exposure unit 3Y, a developing unit 4Y, and a cleaning unit 6Y around a photoreceptor 1Y which is an image forming body, and forms a yellow (Y) toner image on the photoreceptor 1Y. Further, in the present embodiment, at least the photoreceptor 1Y, the charging unit 2Y, the developing unit 4Y, and the cleaning unit 6Y are provided so as to be integrated in the image forming unit 10Y.

The charging unit 2Y is a device of providing a uniform electric potential to the photoreceptor 1Y. In the present invention, the charging unit may be a contact or non-contact roller charging system, but a contact roller charging system is preferable in that the effect of the present invention is more effective.

The exposure unit 3Y exposes the photoreceptor 1Y, which is given a uniform electric potential by the charging unit 2Y, based on the image signal (yellow) to form an electrostatic charge image corresponding to the yellow image. As an exposure unit 3Y, one composed of LEDs and imaging elements in which light emitting elements are arranged in an array in the axial direction of the photoreceptor 1Y, or a laser optical system is used.

The developing unit 4Y contains, for example, a developing sleeve having a built-in magnet and rotating while holding a two-component developer, and a voltage applying device for applying a DC and/or AC bias voltage between the photoreceptor 1Y and the developing sleeve.

The cleaning unit 6Y is composed of a cleaning blade provided so that the tip thereof abuts on the surface of the photoreceptor 1Y, and a brush roller provided on the upstream side of the cleaning blade and in contact with the surface of the photoreceptor 1Y. The cleaning blade has a function of removing residual toner adhering to the photoreceptor 1Y and a function of scraping the surface of the photoreceptor 1Y.

The brush roller has a function of removing residual toner adhering to the photoreceptor 1Y, a function of recovering the residual toner removed by the cleaning blade, and a function of scraping the surface of the photoreceptor 1Y. That is, the brush roller is in contact with the surface of the photoreceptor 1Y, and at the contact portion, the brush roller rotates in the same direction as that of the photoreceptor 1Y, and the residual toner and paper dust on the photoreceptor 1Y are removed, and the residual toner removed by the cleaning blade is conveyed and collected.

Here, the photoreceptor according to the present invention is ensured to have memory performance by containing the charge transport material (1) or (2) in the photosensitive layer of the photoreceptor. Further, the toner according to the present invention may contain lanthanum-doped titanic acid compound particles as an external additive, so that the amount of charge of the toner is controlled, the adhesive force of the toner to the photoreceptor is weakened, and the wiping property at the time of cleaning is improved. Thus, an image forming system having excellent cleaning performance is provided. As a result, the direct damage to the photoreceptor is reduced, and the occurrence of filming due to the decrease in the adhesive force on the photoreceptor is suppressed. In this way, in the image forming system of the present invention, the photoreceptor may maintain high durability while achieving both cleaning performance and memory performance, so that a high-quality image can be stably supplied even in long-term use.

In the image forming system using the image forming apparatus 100, the transfer step of transferring the toner image formed on the photoreceptor to the transfer material uses an intermediate transfer body as described below. This is an embodiment in which a toner image is primarily transferred onto an intermediate transfer body, and then the toner image is secondarily transferred onto a transfer material.

The toner images of each color formed from the image forming units 10Y, 10M, 10C, and 10Bk are sequentially transferred onto the rotating endless belt-shaped intermediate transfer body 70 by the primary transfer rollers 5Y, 5M, 5C, and 5Bk as a primary transfer means, and a synthesized color image is formed. The endless belt-shaped intermediate transfer body 70 is a semi-conductive endless belt-shaped second image carrier wound and rotatably supported by a plurality of rollers 71, 72, 73 and 74.

The color image synthesized on the endless belt-shaped intermediate transfer body 70 is then transferred to the transfer material P (image support carrying the fixed final image: for example, plain paper, transparent sheet, etc.). Specifically, the transfer material P stored in the paper cassette 20 is fed by a paper feeding unit 21, and it is conveyed to a secondary transfer roller 5b as a secondary transfer means via a plurality of intermediate rollers 22A, 22B, 22C, 22D, and the 23. Then, with the secondary transfer roller 5b, the color image is batch-transferred (secondary transfer) from the endless belt-shaped intermediate transfer body 70 onto the transfer material P. The transfer material P to which the color image is transferred is fixed by a fixing unit 24, sandwiched between the paper exit roller 25, and placed on the paper exhaust tray 26 outside the machine.

The fixing unit 24 is, for example, a heat roller fixing device composed of a heat roller provided with a heating source inside and a pressure roller provided in a state of being pressure-contacted so as to form a fixing nip portion on the heat roller.

On the other hand, after the color image is transferred to the transfer material P by the secondary transfer roller 5b as a secondary transfer means, the residual toner on the endless belt-shaped intermediate transfer body 70 is removed by the cleaning unit 6b.

During the image forming process, the primary transfer roller 5Bk is always in contact with the photoreceptor 1Bk. The other primary transfer rollers 5Y, 5M, and 5C abut on the corresponding photoreceptors 1Y, 1M, and 1C only during color image formation. The secondary transfer roller 5b comes into contact with the endless belt-shaped intermediate transfer body 70 only when the transfer material P passes through here and the secondary transfer is performed.

Further, in the image forming apparatus 100, a housing 8 including the image forming units 10Y, 10M, 10C, and 10Bk and the intermediate transfer body unit 7 may be pulled out from the apparatus main body A via support rails 82L and 82R.

Although the image forming system in a color laser printer has been described using the image forming apparatus 100 shown in the FIGURE, the image forming system is equally applicable to monochrome laser printers and copy machines. The exposure light source may also be a light source other than a laser, for example, an LED light source.

### EXAMPLES

Hereinafter, the present invention will be specifically described with reference to examples, but the present invention is not limited thereto. Although the description of “parts” or “%” is used in the examples, it represents “parts by mass” or “mass %” unless otherwise specified.

### <Preparation of External Additives>

### <Preparation of External Additives 1 to 12>

3.0 parts by mass of pure water was sprayed onto the silica particles produced by the vapor phase method having a number average primary particle diameter of 30 nm under a nitrogen atmosphere while stirring. To this, 15 parts by mass of dimethyldichlorosilane and 1.0 part by mass of diethylamine, which are surface modifiers, were sprayed. The mixture was heated with stirring at 180° C. for 1 hour, then cooled, and dried under reduced pressure to obtain an external additive 1. Similarly, in the preparation of the external additives 2 to 12, the surface modifiers were changed to the materials shown in Table I and the same treatment was performed.

As an external additive 12, silica particles having a number average primary particle diameter shown in Table I and produced by the vapor phase method were used, and the same treatment as that of the external additive 1 was performed.

### <Preparation of External Additives 13 to 15>

3.0 parts by mass of pure water was sprayed on the alumina particles having a number average primary particle diameter of 30 inn, which were produced with reference to the contents described in JP-A 2012-224542, under a nitrogen atmosphere while stirring. To this, 20 parts by mass of ethyltrimethoxysilane and 1.0 part by mass of diethylamine, which are surface modifiers, were sprayed. The mixture was heated with stirring at 180° C. for 1 hour, then cooled, and dried under reduced pressure to obtain an external additive 14. The number average primary particle diameter thereof was 30 nm.

The external additives 14 and 15 were prepared by changing the surface modifier to the materials shown in Table I and performing the same treatment.

### <Preparation of External Additives 16 to 20>

In a 1 L reactor equipped with a stirrer, a dropping funnel, and a thermometer, 500 parts by mass of methanol was stirred and 10 parts by mass of titanium isopropoxide was dropped. The mixture was stirred for 10 minutes. The resulting titanium dioxide particles were then separated and collected by centrifuge, and then dried under reduced pressure to obtain metatitanic acid with a number average primary particle diameter of 30 nn. The metatitanic acid was sprayed with 3.0 masses of pure water while stirring under a nitrogen atmosphere. To this, 20 parts by mass of ethyltrimethoxysilane and 1.0 part by mass of diethylamine, which are surface modifiers, were sprayed. The mixture was heated and stirred at 180° C. for 1 hour. Afterwards, it was cooled and dried under reduced pressure to obtain external additive 16. The external additives 17 and 18 were prepared by changing the surface modifier to the materials shown in the table and performing the same treatment.

The obtained metatitanic acid was heated in a high-temperature electric furnace at 800° C. for 5 hours in air to obtain titanium dioxide particles. The obtained titanium dioxide particles were sprayed with 3.0 parts by mass of pure water while stirring under a nitrogen atmosphere. To this, 20 parts by mass of ethyltrimethoxysilane and 1.0 part by mass of diethylamine, which are surface modifiers, were sprayed. After that, it was cooled and dried under reduced pressure to obtain external additive 19. The external additive 20 was prepared by changing the surface modifier to the materials shown in Table I and performing the same treatment. The number average primary particle diameter of the titanium dioxide particles was 30 nm.

### <Preparation of External Additives 21 and 22>

The metatitanic acid dispersion liquid was desulfurized by adjusting the pH to 9.0 with a 4.0 mol/liter sodium hydroxide aqueous solution. Then, a 6.0 mol/liter aqueous hydrochloric acid solution was added to adjust the pH to 5.5 for neutralization. After that, the metatitanic acid dispersion liquid was filtered and washed with water to obtain a cake of metatitanic acid. Water was added to the cake to prepare a dispersion liquid corresponding to 1.25 mol/liter in terms of titanium oxide TiO₂, and then the pH was adjusted to 1.2 with a 6.0 mol/liter hydrochloric acid aqueous solution. Then, the temperature of the dispersion was adjusted to 35° C., and the mixture was stirred at this temperature for 1 hour to deflocculate the metatitanic acid dispersion liquid.

Metatitanic acid equivalent to 0.156 mol of titanium oxide TiO₂ was collected from the deflocculated metatitanic acid dispersion liquid and charged into the reaction vessel, and then the calcium carbonate CaCO₃ aqueous solution was charged into the reaction vessel. At this time, the reaction system was prepared so that the titanium oxide concentration was 0.156 mol/liter. Calcium carbonate CaCO₃ was added to titanium dioxide at a molar ratio of 1.15 (aCO₃/TiO₂=1.15/1.00). Nitrogen gas was supplied to the above reaction vessel and left for 20 minutes to create a nitrogen gas atmosphere inside the vessel, and then the mixed solution composed of metatitanic acid and calcium carbonate was heated to 90° C. Then, aqueous sodium hydroxide solution was added over a period of 5 hours until the pH reached 8.0. The reaction was terminated by continuing stirring for 1 hour at 90° C. After completion of the reaction, the inside of the reaction vessel was cooled to 40° C., and the supernatant liquid was removed under a nitrogen atmosphere. 2,500 parts by mass of pure water was put into the reaction vessel and decantation was repeated twice. After decantation, the reaction system was filtered through a Nutsche filter to form a cake product, and the resulting cake product was heated to 110° C. and dried in air for 8 hours. The resulting dried calcium titanate was placed in an alumina crucible and dehydrated at 930° C. and subjected to calcination. After calcination, the calcium titanate was put into water and wet-milled with a sand grinder to make a dispersion liquid, and then a 6.0 mol/liter hydrochloric acid solution was added to adjust the pH to 2.0 to remove the excess calcium carbonate.

After removing the excess calcium carbonate, a diluted solution of ethyltrimethoxysilane or isobutyltrimethoxysilane (10 parts by mass of isobutyl silane/90 parts by mass of ethanol) was prepared and used for the surface modification treatment. The surface modification was carried out by stirring for 30 minutes with a Henschel mixer in a nitrogen atmosphere. At that time, 5.0 parts by mass of isobutyltrimethoxysilane was added to 100 parts by mass of calcium titanate solids for treatment. After the aforementioned wet surface treatment was performed, a 4.0 mole/liter sodium hydroxide solution was added to adjust the pH to 6.5 for neutralization treatment. After that, it was filtered, washed, and dried at 150° C. Further, a crushing treatment was carried out for 60 minutes using a mechanical crushing device to prepare an external additive 21 using calcium titanate. The number average primary particle diameter was 30 inn. The external additive 22 was prepared by changing the surface modifier to the material shown in Table I and performing the same treatment.

### <Measurement of Number Average Primary Particle Diameter>

The number average primary particle diameter was measured using a transmission electron microscope (EM-2100, manufactured by JEOL Ltd.) with a 30,000 times expanded field of view. The diameter in a certain direction at the distance between two parallel lines in a certain direction sandwiching 200 or more and 500 or less primary particles was measured, the values of the upper 5% and the lower 5% were removed, and average the remaining 90% to use as an average diameter.

TABLE I

| External | | Number average | | | |
|---|---|---|---|---|---|
| additive | | primary particle | Surface modifier | | |
| No. | Material | diameter [nm] | R₁ | X | n |
| External | Silica | 30 | CH₃ | Cl | 2 |
| additive 1 | | | | | |
| External | Silica | 30 | C₂H₃ | Cl | 2 |
| additive 2 | | | | | |
| External | Silica | 30 | C₄H₉ | Cl | 2 |
| additive 3 | | | | | |
| External | Silica | 30 | C₂H₅ | OCH₃ | 3 |
| additive 4 | | | | | |
| External | Silica | 30 | C₂H₅ | OC₂H₅ | 3 |
| additive 5 | | | | | |
| External | Silica | 30 | C₂H₅ | OC₂H₅ | 1 |
| additive 6 | | | | | |
| External | Silica | 30 | C₄H₉ | OCH₃ | 3 |
| additive 7 | | | | | |
| External | Silica | 30 | C₈H₁₇ | OCH₃ | 3 |
| additive 8 | | | | | |
| External | Silica | 30 | C₁₀H₂₁ | OCH₃ | 3 |
| additive 9 | | | | | |
| External | Silica | 30 | C₁₆H₃₃ | OCH₃ | 3 |
| additive 10 | | | | | |
| External | Silica | 30 | HMDS | | |
| additive 11 | | | | | |
| External | Silica | 80 | C₂H₅ | OCH₃ | 3 |
| additive 12 | | | | | |
| External | Alumina | 30 | C₂H₅ | OCH₃ | 3 |
| additive 13 | | | | | |
| External | Alumina | 30 | C₄H₉ | OCH₃ | 3 |
| additive 14 | | | | | |
| External | Alumina | 30 | C₈H₁₇ | OCH₃ | 3 |
| additive 15 | | | | | |
| External | Metatitanic | 30 | C₂H₅ | OCH₃ | 3 |
| additive 16 | acid | | | | |
| External | Metatitanic | 30 | C₄H₉ | OCH₃ | 3 |
| additive 17 | acid | | | | |
| External | Metatitanic | 30 | C₈H₁₇ | OCH₃ | 3 |
| additive 18 | acid | | | | |
| External | Titanium | 30 | C₂H₅ | OCH₃ | 3 |
| additive 19 | oxide | | | | |
| External | Titanium | 30 | C₄H₉ | OCH₃ | 3 |
| additive 20 | oxide | | | | |
| External | Calcium | 30 | C₂H₅ | OCH₃ | 3 |
| additive 21 | titanate | | | | |
| External | Calcium | 30 | C₄H₉ | OCH₃ | 3 |
| additive 22 | titanate | | | | |

### <Preparation of Core Material Particles for Carrier Particles>

Appropriate amounts of each raw material were mixed so as to be 19.0 mol % in terms of MnO, 2.8 mol % in terms of MgO, 1.5 mol % in terms of SrO, and 75.0 mol % in terms of Fe₂O₃. Water was added, crushed in a wet ball mill for 10 hours, then, mixed, dried and kept at 950° C. for 4 hours. The slurry that had been pulverized for 24 hours with a wet ball mill was granulated and dried, 50% of the volume was added to the firing furnace with a built-in stirrer, and the slurry was held at a peripheral speed of 10 m/s and 1400° C. for 4 hours. Then crushed and the particle size was adjusted to 32 mm in diameter. Thus, the core material particles for carrier particles 1 were obtained. The shape factor (SF-1) of the core material particles for carrier particles 1 was 140.

Similarly, the sintering temperature was varied under the conditions shown in Table II to produce core material particles 2 to 6 for carrier particles.

### <Measuring Method of Shape Factor>

The shape factor is calculated by taking a photograph of more than 100 particles randomly at an enlargement of 150 using a scanning electron microscope, and using a scanner to capture the photographic image. The photographic image captured by the scanner was measured using an image processing analysis device (LUZEX AP, manufactured by Nireco Corporation). The shape factor (SF-1) of the core material particles is calculated by the following Equation (1).

SF-1=(Maximum length of the particle)²/(Projected area of the particle)×(7/4)×100 Equation (1):

The shape factor indicates the degree of unevenness of the core material particles to be measured, and the more intense the undulations of the surface, the larger the value.

TABLE II

| Core material particles No. | Sintering temperature | SF-1 |
|---|---|---|
| Core material particles 2 | 1050° C. | 110 |
| Core material particles 3 | 1200° C. | 115 |
| Core material particles 4 | 1340° C. | 130 |
| Core material particles 1 | 1400° C. | 140 |
| Core material particles 5 | 1450° C. | 150 |
| Core material particles 6 | 1500° C. | 155 |

### <Preparation of Resin for Coating Core Material (Coating Material 1)>

Cyclohexyl methacrylate and methyl methacrylate were added in a molar ratio of 1:1 to an aqueous solution of 0.3 mass % of sodium benzene sulfonate. An amount of potassium persulfate equivalent to 0.5 mass % of the total monomer was added, and emulsion polymerization was carried out. The resin particles in the resulting dispersion liquid were dried by spray drying to produce a coating material 1, which is the resin for coating the core material. The weight average molecular weight (Mw) of the obtained coating material 1 was 500,000. The weight average molecular weight (Mw) of the coating material 1 was determined by gel permeation chromatography (GPC).

<Preparation of carrier particles 3>

100 parts by mass of Mn—Mg ferrite particles with a volume average particle diameter of 32 μm and a shape factor SF-1 of 140 were fed into a high-speed agitator-mixer with a horizontal agitator blade, and 3.2 parts by mass of the coating material 1 were mixed and stirred for 15 minutes at 22° C. under the condition that the peripheral speed of the horizontal rotor blade was 8 m/sec. The mixture was stirred at 22° C. for 15 minutes under the condition that the peripheral speed of the horizontal rotating blade was 8 m/sec. After that, the particles were mixed at 120° C. for 50 minutes to coat the surface of the above core material particles with the coating material 1 by the action of mechanical impact force (mechanochemical method). Thus, the carrier particles 3 were prepared. The median diameter of the carrier particles 3 was 33 μm based on volume distribution. The value of the iron element content, which indicates the extent of the exposed area of the core particles, was 8.2%.

### <Measurement of Volume Average Particle Diameter of Carrier Particles>

The volume average particle diameter of the carrier particles is a value obtained by measuring by a wet method using a laser diffraction type particle size distribution measuring device (HELOS KA, manufactured by Nippon Laser Co., Ltd.). Specifically, first, an optical system with a focal position of 200 mm was selected, and the measurement time was set to 5 seconds. Then, the carrier core material for measurement was added to a 0.2 mass % sodium dodecyl sulfate solution and washed with an ultrasonic cleaner (US-1, manufactured by As One Corporation) for 3 minutes to obtain a sample dispersion for measurement. Then a few drops of the dispersion were fed into the laser diffraction particle size analyzer, and measurement was started when the sample concentration gauge reached the measurable range. The cumulative distribution of the obtained particle size distribution was made from the small diameter side to the particle size range (channel), and the volume average particle diameter was calculated based on this distribution.

### <Iron Element Content on Surface of Carrier Particles>

The iron element content (atomic %) was calculated by the following method. K-Alpha manufactured by Thermo Fisher Scientific, Corp, was used for measurement. The measurement was made using Al monochromatic X-rays as an X-ray source, with an acceleration voltage of 7 kV and an emission current of 6 mV. By XPS measurement (X-ray photoelectron spectroscopy measurement), the CIs spectrum was measured for carbon, the Fe2p3/2 spectrum was measured for iron, and the O1s spectrum was measured for oxygen. Then, based on the spectra of each of these atoms, the contents (atomic %) of Fe, C, and O in the unit area of the carrier particle surface represented by “AC”, “AO”, and “AFe”, respectively, were determined. It was calculated and calculated from the following Expression (2).

Iron element content (atomic %)=A_{Fe}/(A_{c}+Aₒ+A_{Fe}) Expression (2):

Here, A_{Fe}, A_{c} and Aₒ each represent the content (atomic %) of Fe, C and O in a unit area of the carrier particle surface, respectively.

Similarly, carrier particles 1, 2, and 4 to 11 were produced by changing the type of core material particles and the amount of resin for coating as shown in Table III below.

TABLE III

| Carrier | | Core | Amount of | Iron element |
|---|---|---|---|---|
| particles | Core material | material | coating resin | content |
| No. | particles No. | SF-1 | (parts by mass) | (atomic %) |
| Carrier 1 | Core material | 140 | 4.10 | 3.5 |
| | particles 1 | | | |
| Carrier 2 | Core material | 140 | 3.95 | 4.0 |
| | particles 1 | | | |
| Carrier 3 | Core material | 140 | 3.20 | 8.2 |
| | particles 1 | | | |
| Carrier 4 | Core material | 140 | 2.90 | 10.9 |
| | particles 1 | | | |
| Carrier 5 | Core material | 140 | 1.95 | 15.0 |
| | particles 1 | | | |
| Carrier 6 | Core material | 140 | 1.80 | 15.2 |
| | particles 1 | | | |
| Carrier 7 | Core material | 110 | 2.65 | 7.9 |
| | particles 2 | | | |
| Carrier 8 | Core material | 115 | 2.75 | 8.1 |
| | particles 3 | | | |
| Carrier 9 | Core material | 130 | 2.90 | 7.9 |
| | particles 4 | | | |
| Carrier 10 | Core material | 150 | 3.35 | 8.0 |
| | particles 5 | | | |
| Carrier 11 | Core material | 155 | 3.45 | 7.9 |
| | particles 6 | | | |

### <Preparation of Toner Base Particles>

### <Preparation of Dispersion Liquid BK of Black Colorant Particles>

90 parts by mass of n-dodecyl sulfate sodium was stirred and dissolved in 1,600 parts by mass of ion-exchanged water, and while stirring this solution, 420 parts by mass of carbon black “Mogul L” (manufactured by Cabot Corporation, pH 2 (room temperature 25° C.)) was gradually added.

Next, a dispersion liquid BK of black colorant fine particles in which carbon black particles were dispersed was prepared by dispersion treatment using a stirrer “CLEARMIX” (manufactured by M-Technique Co., Ltd.).

When the particle size of the black colorant fine particles in this dispersion was measured using a Microtrack particle size distribution measuring device “UPA-150” (manufactured by Nikkiso Co., Ltd.), it was 77 nm in volume-based median diameter.

### (Synthesis of Crystalline Polyester Resin C1)

200 parts by mass of dodecanedioic acid and 102 parts by mass of 1,6-hexanediol were charged in a reaction vessel equipped with a stirrer, a nitrogen gas introduction tube, a temperature sensor and a distillation tower, and the temperature of the reaction system was raised to 190° C. over a period of 1 hour. Then, 0.3 parts by mass of titanium tetrabutoxide was added as a catalyst. Further, the temperature of the reaction system was raised from 190° C. to 240° C. over a period of 6 hours while distilling off the generated water. The dehydration condensation reaction was continued for 6 hours while maintaining the temperature at 240° C. to carry out a polymerization reaction to obtain a crystalline polyester resin c L.

The resulting crystalline polyester resin had a weight average molecular weight of 14,500 and a melting point of 70° C.

### (Measurement of Weight Average Molecular Weight)

A GPC device “HLC-8220” (manufactured by Tosoh Corporation) equipped with columns “TSKguardcolumn+TSKgelSuperHZM-M triple” (manufactured by Tosoh Corporation) was used. The column temperature was maintained at 40° C. while tetrahydrofuran (THF) as a carrier solvent at a flow rate of 0.2 mL/min while maintaining the column temperature at 40° C. 10 μL of the sample solution was injected into the above apparatus. It was detected using a refractive index detector (RI detector), and the molecular weight distribution possessed by the measured sample was determined by calculating using a calibration curve measured using monodisperse polystyrene standard particles.

### (Measurement of Melting Point of Crystalline Resin)

The melting point of the crystalline resin was measured using a differential scanning calorimetry system “Diamond DSC” (PerkinElmer Co., Ltd.). 3.0 mg of the sample was sealed in an aluminum pan and set in a holder, and an empty aluminum pan was set as a reference. The first heating process of raising the temperature from 0° C. to 200° C. at a rate of 10° C./min, the cooling process of cooling from 200° C. to 0° C. at a cooling rate of 10° C./min, and the second heating process of raising the temperature from 0° C. to 200° C. at a rate of 10° C./min were done. By the measuring conditions (raising and cooling conditions) as described above, a DSC curve was obtained. Based on the DSC curve, the endothermic peak top temperature derived from the crystalline polyester in the first temperature increase process was used as a melting point.

### <Preparation of Crystalline Polyester Resin Particle Dispersion Liquid C1>

100 parts by mass of the crystalline polyester resin c1 obtained above was dissolved in 400 parts by mass of ethyl acetate, and it was mixed with 638 parts by mass of a 0.26 mass % concentration sodium dodecyl sulfate aqueous solution prepared in advance. The resulting mixed solution was stirred and homogenized with an ultrasonic homogenizer US-150T (manufactured by Nippon Seiki Co., Ltd.) at V-LEVEL 300 μA for 30 minutes.

After that, with the temperature heated to 50° C., ethyl acetate was completely removed while stirring for 3 hours under reduced pressure using a diaphragm vacuum pump V-700 (manufactured by BUCHI Corporation) to prepare crystalline polyester resin particle dispersion liquid C1. The crystalline polyester resin particles in the dispersion liquid had a median diameter of 148 nm on a volume basis.

### <Preparation of Styrene-Acrylic Resin Particle Dispersion Liquid S1 for Core>

### (First Stage Polymerization)

4 parts by mass of sodium dodecyl sulfate and 3,000 parts by mass of ion-exchanged water were placed in a reaction vessel equipped with a stirrer, a temperature sensor, a cooling pipe, and a nitrogen gas introduction device. The internal temperature was raised to 80° C. while stirring at a stirring speed of 230 rpm under a nitrogen stream. After the temperature was raised, a solution of 10 parts by mass of potassium persulfate dissolved in 200 parts by mass of ion-exchange water was added, and the liquid temperature was raised to 80° C. again, a mixed solution of the following monomers was added dropwise over 2 hours.

Styrene (St): 570.0 parts by mass

n-Butyl acrylate (BA): 165.0 parts by mass

Methacrylic acid (MAA): 68.0 parts by mass

After dropping the above mixture, polymerization was carried out by heating and stirring at 80° C. for 2 hours to prepare the dispersion liquid 1-a of styrene-acrylic resin particles for the core.

### (Second Stage Polymerization)

A solution of 3 parts by mass of sodium polyoxyethylene (2) dodecyl ether sulfate dissolved in 12 parts by mass of ion-exchanged water was placed in a reaction vessel equipped with a stirrer, a temperature sensor, a cooling pipe, and a nitrogen introduction device, and was heated to 80° C. After heating, 60 parts by mass (in solid content) of amorphous vinyl resin particle dispersion liquid 1-a prepared by the above-mentioned first stage polymerization and a mixture of the following monomers, a chain transfer agent and a mold release agent dissolved at 80° C. were added.

Styrene (St): 245.0 parts by mass

2-Ethylhexyl acrylate (2EHA): 97.0 parts by mass

Methacrylic acid (MAA): 3 0.0 parts by mass

n-Octyl-3-mercaptopropionate: 4.0 parts by mass

Microcrystalline wax “HNP-0190” (manufactured by Nippon Seiro): 170.0 parts by mass

A mechanical disperser CLEARMIX™ (manufactured by M-Technique Co., Ltd.) having a circulation path was used for dispersion treatment of mixing for 1 hour to prepare a dispersion liquid containing emulsified particles (oil droplets). To this dispersion liquid, a solution of a polymerization initiator in which 5.2 parts by mass of potassium persulfate was dissolved in 200 parts by mass of ion-exchanged water and 1,000 parts by mass of ion-exchanged water were added, and this system was heated at 84° C. for 1 hour to carry out polymerization to prepare a dispersion liquid 1-b of styrene-acrylic resin particle for a core.

### (Third Stage Polymerization)

A solution of 7 parts by mass of potassium persulfate dissolved in 130 parts by mass of ion-exchanged water was added to the dispersion liquid 1-b of styrene-acrylic resin particles for core obtained by the second-stage polymerization described above. Furthermore, a mixture of the following monomers and a chain transfer agent was added dropwise over a period of 1 hour under the temperature condition of 82° C.

Styrene (St): 350 parts by mass

Methyl methacrylate (MMA): 50 parts by mass

n-Butyl acrylate (BA): 170 parts by mass

Methacrylic acid (MAA): 35 parts by mass

n-Octyl-3-mercaptopropionate: 8.0 parts by mass

After completion of the dropping, polymerization was carried out by heating and stirring for 2 hours, and then cooled to 28° C. to prepare a dispersion liquid S1 of styrene-acrylic resin particles for the core. The styrene-acrylic resin particles in the dispersion liquid had a median diameter of 145 nm on a volume basis. The weight average molecular weight of the obtained styrene-acrylic resin was 35,000, and the glass transition temperature (Tg) was 37° C.

### (Measurement of Glass Transition Temperature)

The glass transition point is a value measured by the method (DSC method) specified in ASTM (American Society for Testing and Materials) D3418-82.

Specifically, 4.5 mg of the sample was weighed to two decimal places. The sample was sealed in an aluminum pan and set in the sample holder of a differential scanning calorimeter “DSC8500” (PerkinElmer Co., Ltd.). An empty aluminum pan was used as a reference, and the measurement temperature ranged from −0 to 120° C. The temperature control of Heat-Cool-Heat was done at a measurement temperature range of −0 to 120° C., a temperature rise rate of 10° C./min, and a temperature decrease rate of 10° C./min. The data from the second heating was used for analysis. The glass transition temperature is the value at the intersection of the extension line of the baseline before the rise of the first endothermic peak and the tangent line showing the maximum slope between the rise of the first endothermic peak and the peak apex.

### <Synthesis of Amorphous Polyester Resin>

### (Synthesis of Styrene-Acrylate Modified Polyester Resin A1)

The following mixture was placed in a four-necked flask with a capacity of 10 liters equipped with a nitrogen inlet tube, a dehydration tube, a stirrer, and a thermocouple.

Bisphenol A propylene oxide 2-mol adduct: 500 parts by mass

Terephthalic acid: 117 parts by mass

Fumaric acid: 82 parts by mass

Esterification catalyst (tin octylate): 2 parts by mass

The mixture was allowed to condensation polymerization at 30° C. for 8 hours, and then cooled to obtain amorphous polyester resin A1.

### (Synthesis of Styrene-Acrylate Modified Polyester Resin B1)

The following mixture was placed in a four-necked flask with a capacity of 10 liters equipped with a nitrogen inlet tube, a dehydration tube, a stirrer, and a thermocouple.

Bisphenol A propylene oxide 2-mol adduct: 500 parts by mass

Terephthalic acid: 117 parts by mass

Fumaric acid: 82 parts by mass

Esterification catalyst (tin octylate): 2 parts by mass

The mixture was subjected to condensation polymerization at 230° C. for 8 hours, and further reacted at 8 kPa for 1 hour. After the reaction was cooled to 160° C., the following mixture was added dropwise over a period of 1 hour using a dropping funnel.

Acrylic acid: 10 parts by mass

Styrene: 15 parts by mass

Butyl acrylate: 4 parts by mass

Polymerization initiator (di-t-butyl peroxide): 10 parts by mass

After dropping the mixture, the addition polymerization reaction was continued at 160° C. for 1 hour, and then the temperature was raised to 200° C. After maintaining the temperature at 10 kPa for 1 hour, acrylic acid, styrene, and butyl acrylate were removed to obtain a styrene-acrylate modified polyester resin B1.

### (Synthesis of Styrene-Acrylate Modified Polyester Resins B2 to B5)

Styrene-acrylate modified polyester resins B2 to B5 were made by changing the monomer amounts in Table IV below (in the table, “St” represents “styrene” and “Ac” represents “acrylate”).

TABLE IV

| | Polyhydric alcohol | | Polyvalent carboxylic acid monomer | | | | | | | |
|---|---|---|---|---|---|---|---|---|---|---|
| | monomer No. | | Saturated aliphatic | | Unsaturated aliphatic | | | | Ac | |
| | Bisphenol A | | dicarboxylic acid | | dicarboxylic acid | | Bi-reactive | St | monomer | |
| | propylene | | Terephthalic | | Fumaric | | monomer | monomer | Butyl | Content |
| Polyester | oxide | | acid | | acid | | Acrylic acid | Styrene | acrylate | of |
| resin | (parts by | | (parts by | | (parts by | | (parts by | (parts by | (parts by | St-Ac |
| No. | mass) | mol | mass) | mol | mass) | mol | mass) | mass) | mass) | (mass %) |
| A1 | 500 | 1.45 | 117 | 0.70 | 82 | 0.71 | — | — | — | 0% |
| B1 | 500 | 1.45 | 117 | 0.70 | 82 | 0.71 | 10 | 15 | 4 | 3% |
| B2 | 500 | 1.45 | 117 | 0.70 | 82 | 0.71 | 10 | 30 | 7 | 5% |
| B3 | 500 | 1.45 | 117 | 0.70 | 82 | 0.71 | 10 | 142 | 35 | 20% |
| B4 | 500 | 1.45 | 117 | 0.70 | 82 | 0.71 | 10 | 243 | 61 | 30% |
| B5 | 500 | 1.45 | 117 | 0.70 | 82 | 0.71 | 10 | 305 | 76 | 35% |

### <Preparation of Polyester Resin Particle Dispersion Liquid D1>

100 parts by mass of the amorphous polyester resin A1 obtained above was dissolved in 400 parts by mass of ethyl acetate, and it was mixed with 638 parts by mass of a 0.26 mass % concentration sodium dodecyl sulfate aqueous solution prepared in advance. The resulting mixed solution was stirred and homogenized with an ultrasonic homogenizer US-150T (manufactured by Nippon Seiki Co., Ltd.) at V-LEVEL 300 μA for 30 minutes.

After that, with the temperature heated to 50° C., ethyl acetate was completely removed while stirring for 3 hours under reduced pressure using a diaphragm vacuum pump V-700 (manufactured by BUCHI Corporation) to prepare amorphous polyester resin particle dispersion liquid D1. The amorphous polyester resin particles in the dispersion liquid had a median diameter of 180 nm on a volume basis.

### <Preparation of Toner Base Particles 1 (Aggregation and Fusion Process>

In a 5 L reaction vessel equipped with a stirrer, a temperature sensor, a cooling tube, and a nitrogen introduction device, 405 g (in solid content) of the resin fine particle S1 for the core, 45 g (in solid content) of the crystalline polyester resin particle dispersion liquid C1, 1,100 g of ion-exchanged water, and 50 g of the dispersion liquid BK of the colorant particles were charged. The temperature of the obtained dispersion liquid was adjusted to 30° C. The pH of the dispersion liquid was adjusted to 10 by adding 5N sodium hydroxide solution to the dispersion liquid. Then, an aqueous solution of 60 g of magnesium chloride dissolved in 60 g of ion-exchanged water was added to the above dispersion liquid over 10 minutes at 3° C. under stirring. After the addition, the temperature of the dispersion solution was kept at 30° C. for 3 minutes, and then the temperature was raised to 85° C. over a period of 60 minutes. The particle growth reaction was continued while maintaining the temperature of the dispersion liquid at 85° C. to prepare a dispersion liquid of pre-core particles (1). Then, 50 g (in solid content) of resin particle D1 for shell was added to the dispersion liquid, and stirring was continued at 80° C. for 1 hour, and resin particles 1 was obtained by fusing resin particle D1 for shell onto the surface of core particle (1) to form a shell layer. Here, an aqueous solution of 150 g of sodium chloride dissolved in 600 g of ion-exchanged water was added to the obtained dispersion liquid. The dispersion liquid was aged at a temperature of 80° C. When the average circularity of the resin particles 1 became 0.97, it was cooled to 30° C. The median diameter of the toner base particles 1 after cooling was 5.5 μm in number base.

Toner base particles 2 to 6 were prepared by changing the shell portion resin as shown in Table V below.

TABLE V

| | | | | | | Contents of |
|---|---|---|---|---|---|---|
| | Core portion | | Core portion | | | core portion |
| | resin 1 | | resin 2 | | | resin and |
| | | Content in | | Content in | | shell portion |
| Toner | | core | | core | Shell | resin in toner |
| base | | portion | | portion | portion | base |
| particles | | resin | | resin | resin | particles |
| No. | Type | (mass %) | Type | (mass %) | Type | (mass ratio) |
| Base 1 | S1 | 90 | C1 | 10 | A1 | 90/10 |
| Base 2 | S1 | 90 | C1 | 10 | B1 | 90/10 |
| Base 3 | S1 | 90 | C1 | 10 | B2 | 90/10 |
| Base 4 | S1 | 90 | C1 | 10 | B3 | 90/10 |
| Base 5 | S1 | 90 | C1 | 10 | B4 | 90/10 |
| Base 6 | S1 | 90 | C1 | 10 | B5 | 90/10 |

### <Preparation of Toner Particles 1 (External Additive Treatment Process)

The following external additive was added to the toner base particles 3, and placed in a Henschel mixer model “FM20C/I” (manufactured by Nippon Coke & Engineering Co., Ltd.). The mixer was agitated for 15 minutes with the rotation speed of the agitator blade set so that the peripheral speed of the blade tip was 40 m/s. Thus, toner particles 1 were prepared.

External additive 1: 1.5 parts by mass

The temperature of the above-mentioned external additive when mixed with the toner particles 1 was set to be 40° C.±1° C. When the temperature reached 41° C., cooling water was flowed into the outer bath of the Henschel mixer at a flow rate of 5 L/min, and when the temperature reached 39° C., the temperature inside the Henschel mixer was controlled by running cooling water at a flow rate of 1 L/min.

### <Preparation of Toner Particles 2 to 29 (External Additive Treatment Process)

Toner particles 2 to 29 were prepared in the same way as toner particle 1, with the external additive treatment was done as shown in Table VI.

TABLE VI

| Toner | Toner base | External additive | | | | | |
|---|---|---|---|---|---|---|---|
| particles No. | particles No. | Type | mass % | Type | mass % | Type | mass % |
| Toner 1 | Base 3 | External additive 1 | 1.5 | — | — | — | — |
| Toner 2 | Base 3 | External additive 2 | 1.5 | — | — | — | — |
| Toner 3 | Base 3 | External additive 3 | 1.5 | — | — | — | — |
| Toner 4 | Base 3 | External additive 4 | 1.5 | — | — | — | — |
| Toner 5 | Base 3 | External additive 5 | 1.5 | — | — | — | — |
| Toner 6 | Base 3 | External additive 6 | 1.5 | — | — | — | — |
| Toner 7 | Base 3 | External additive 7 | 1.5 | — | — | — | — |
| Toner 8 | Base 3 | External additive 8 | 1.5 | — | — | — | — |
| Toner 9 | Base 3 | External additive 9 | 1.5 | — | — | — | — |
| Toner 10 | Base 3 | External additive 10 | 1.5 | — | — | — | — |
| Toner 11 | Base 3 | External additive 11 | 1.5 | — | — | — | — |
| Toner 12 | Base 3 | External additive 12 | 4.0 | — | — | — | — |
| Toner 13 | Base 3 | External additive 13 | 2.4 | — | — | — | — |
| Toner 14 | Base 3 | External additive 14 | 2.4 | — | — | — | — |
| Toner 15 | Base 3 | External additive 15 | 2.4 | — | — | — | — |
| Toner 16 | Base 3 | External additive 16 | 2.7 | — | — | — | — |
| Toner 17 | Base 3 | External additive 17 | 2.7 | — | — | — | — |
| Toner 18 | Base 3 | External additive 18 | 2.7 | — | — | — | — |
| Toner 19 | Base 3 | External additive 19 | 3.0 | — | — | — | — |
| Toner 20 | Base 3 | External additive 20 | 3.0 | — | — | — | — |
| Toner 21 | Base 3 | External additive 21 | 3.0 | — | — | — | — |
| Toner 22 | Base 3 | External additive 22 | 3.0 | — | — | — | — |
| Toner 23 | Base 1 | External additive 4 | 1.5 | — | — | — | — |
| Toner 24 | Base 2 | External additive 4 | 1.5 | — | — | — | — |
| Toner 25 | Base 4 | External additive 4 | 1.5 | — | — | — | — |
| Toner 26 | Base 5 | External additive 4 | 1.5 | — | — | — | — |
| Toner 27 | Base 6 | External additive 4 | 1.5 | — | — | — | — |
| Toner 28 | Base 3 | External additive 4 | 1.5 | External | 0.5 | — | — |
| | | | | additive 14 | | | |
| Toner 29 | Base 3 | External additive 4 | 1.5 | External | 0.5 | External | 0.5 |
| | | | | additive 14 | | additive 13 | |

### <Preparation of Two-Component Developer 1>

Toner particles 1 and carrier particles 3 were mixed in a V-type mixer for 30 minutes so that the toner content (toner concentration) in the two-component developer was 6 mass %.

### <Preparation of Two-Component Developers 2 to 40>

In the same way as the preparation of the two-component developer 1, the two-component developers 2 to 40 were prepared with the configurations described in Table VII and Table VIII.

### <Evaluation>

The following evaluations were carried out using the produced two-component developers 1 to 40.

As an evaluation device, a commercial digital full-color MFP “Bizhub™ PRESS 1070” (manufactured by Konica Minolta, Inc.) was used. The manufactured two-component developers were respectively loaded and the following evaluations were conducted. In this evaluation system, printing was performed by an electrophotographic image forming method having a charging step, an exposure step, a developing step, and a transfer step.

### (Evaluation of Fog)

After printing 100,000 sheets of a solid strip chart with a print rate of 40% under an environment of 30° C. and 85% RH, the blank sheet of paper was printed and evaluated for the blank sheet density. The density was measured at 20 locations on A4 paper and the average value was used as a blank sheet density. The density was measured by X-Rite 938 (X-Rite Co., Ltd.). “AA” or “BB” is considered to be acceptable in the following judgment criteria.

AA: Density of blank sheet of paper is less than 0.005.

BB: Density of blank sheet of paper is 0.005 or more and less than 0.02.

CC: Density of blank sheet of paper is 0.02 or more.

### (Evaluation of Image Density Variation)

After printing 100,000 copies of a solid strip chart with a print rate of 40% under an environment of 10° C. and 10% RH, an image pattern with 2 cm square solid patches lined up at intervals of one round of the developing sleeve was output. The difference in density between the first round (a) and the second round (b) was measured using the X-Rite 938 (manufactured by X-Rite Co., Ltd.). “AA” or “BB” was considered to be a passing grade according to the following judgment criteria.

AA: Density difference A is less than 0.005

BB: Density difference A is 0.005 or more and less than 0.02.

CC: Density difference A is 0.02 or more.

TABLE VII

| | Toner | Carrier | Evaluation of fog | | Image density variation | | |
|---|---|---|---|---|---|---|---|
| Two-component | particles | particles | Measured | | Measured | | |
| developer No. | No. | No. No. | value | Judgment | value | Judgment | Remarks |
| Developer 1 | Toner 1 | Carrier 3 | 0.013 | BB | 0.004 | AA | Example 1 |
| Developer 2 | Toner 2 | Carrier 3 | 0.004 | AA | 0.004 | AA | Example 2 |
| Developer 3 | Toner 3 | Carrier 3 | 0.003 | AA | 0.011 | BB | Example 3 |
| Developer 4 | Toner 4 | Carrier 3 | 0.002 | AA | 0.003 | AA | Example 4 |
| Developer 5 | Toner 5 | Carrier 3 | 0.002 | AA | 0.003 | AA | Example 5 |
| Developer 6 | Toner 6 | Carrier 3 | 0.002 | AA | 0.010 | BB | Example 6 |
| Developer 7 | Toner 7 | Carrier 3 | 0.004 | AA | 0.013 | BB | Example 7 |
| Developer 8 | Toner 8 | Carrier 3 | 0.004 | AA | 0.021 | CC | Comparative |
| | | | | | | | Example 1 |
| Developer 9 | Toner 9 | Carrier 3 | 0.003 | AA | 0.024 | CC | Comparative |
| | | | | | | | Example 3 |
| Developer 10 | Toner 10 | Carrier 3 | 0.003 | AA | 0.029 | CC | Comparative |
| | | | | | | | Example 4 |
| Developer 11 | Toner 11 | Carrier 3 | 0.021 | CC | 0.016 | BB | Comparative |
| | | | | | | | Example 5 |
| Developer 12 | Toner 12 | Carrier 3 | 0.007 | BB | 0.004 | AA | Example |
| Developer 13 | Toner 13 | Carrier 3 | 0.003 | AA | 0.003 | AA | Example 8 |
| Developer 14 | Toner 14 | Carrier 3 | 0.004 | AA | 0.006 | BB | Example 9 |
| Developer 15 | Toner 15 | Carrier 3 | 0.010 | AA | 0.021 | CC | Comparative |
| | | | | | | | Example 6 |
| Developer 16 | Toner 16 | Carrier 3 | 0.004 | AA | 0.009 | BB | Example 10 |
| Developer 17 | Toner 17 | Carrier 3 | 0.006 | BB | 0.004 | AA | Example 11 |
| Developer 18 | Toner 18 | Carrier 3 | 0.012 | AA | 0.021 | CC | Comparative |
| | | | | | | | Example 7 |
| Developer 19 | Toner 19 | Carrier 3 | 0.011 | BB | 0.009 | BB | Example 12 |
| Developer 20 | Toner 20 | Carrier 3 | 0.009 | BB | 0.012 | BB | Example 13 |
| Developer 21 | Toner 21 | Carrier 3 | 0.005 | AA | 0.006 | BB | Example 14 |
| Developer 22 | Toner 22 | Carrier 3 | 0.007 | BB | 0.005 | AA | Example 15 |
| Developer 23 | Toner 4 | Carrier 1 | 0.003 | AA | 0.022 | CC | Comparative |
| | | | | | | | Example 8 |
| Developer 24 | Toner 4 | Carrier 2 | 0.002 | AA | 0.009 | BB | Example 16 |
| Developer 25 | Toner 4 | Carrier 3 | 0.001 | AA | 0.001 | AA | Example 17 |
| Developer 26 | Toner 4 | Carrier 4 | 0.003 | AA | 0.003 | AA | Example 18 |
| Developer 27 | Toner 4 | Carrier 5 | 0.008 | BB | 0.003 | AA | Example 19 |
| Developer 28 | Toner 4 | Carrier 6 | 0.021 | CC | 0.004 | AA | Comparative |
| | | | | | | | Example 9 |
| Developer 29 | Toner 4 | Carrier 7 | 0.006 | BB | 0.013 | BB | Example 20 |
| Developer 30 | Toner 4 | Carrier 8 | 0.004 | AA | 0.003 | AA | Example 21 |
| Developer 31 | Toner 4 | Carrier 9 | 0.003 | AA | 0.004 | AA | Example 22 |

TABLE VIII

| | | | | | Image density | | |
|---|---|---|---|---|---|---|---|
| | Toner | Carrier | Evaluation of fog | | variation | | |
| Two-component | particles | particles | Measured | | Measured | | |
| developer No. | No. | No. | value | Judgment | value | Judgment | Remarks |
| Developer 32 | Toner 4 | Carrier 10 | 0.003 | AA | 0.004 | AA | Example 23 |
| Developer 33 | Toner 4 | Carrier 11 | 0.007 | BB | 0.013 | BB | Example 24 |
| Developer 34 | Toner 23 | Carrier 3 | 0.002 | AA | 0.012 | BB | Example 25 |
| Developer 35 | Toner 24 | Carrier 3 | 0.002 | AA | 0.007 | AA | Example 26 |
| Developer 36 | Toner 25 | Carrier 3 | 0.004 | AA | 0.004 | AA | Example 27 |
| Developer 37 | Toner 26 | Carrier 3 | 0.008 | AA | 0.003 | AA | Example 28 |
| Developer 38 | Toner 27 | Carrier 3 | 0.011 | BB | 0.003 | AA | Example 29 |
| Developer 39 | Toner 28 | Carrier 3 | 0.001 | AA | 0.002 | AA | Example 30 |
| Developer 40 | Toner 29 | Carrier 3 | 0.003 | AA | 0.001 | AA | Example 31 |

From Tables VII and VIII, it can be seen that Examples 1 to 31, which are the two-component developers for electrostatic charge image development of the present invention, have improved charge rise performance and suppressed fog compared to Comparative Examples 1 to 9. It can be seen that the toner charge amount is stable even under environmental changes, and the toner has excellent resistance to fluctuations in image density.

### DESCRIPTION OF SYMBOLS

101: Conductive support
102: Intermediate layer
103: Photosensitive layer
103a: Charge generation layer
103b: Charge transport layer
103c: Surface protection layer
100: Image forming apparatus
1A, 1B, 1Y, 1M, 1C, 1Bk: Photoreceptor
2Y, 2M, 2C, 2Bk: Charging unit
3Y, 3M, 3C, 3Bk: Exposure unit
4Y, 4M, 4C, 4Bk: Developing unit
5Y, 5M, 5C, 5Bk: Primary transfer roller
5b: Secondary transfer roller
6Y, 6M, 6C, 6Bk, 6b: Cleaning unit
7: Intermediate transfer body unit
8: Housing
10Y, 10M, 10C, 10Bk: Image forming unit
21: Paper feeding unit
20: Paper cassette
22A, 22B, 22C, 22D: Intermediate roller
23: Resist roller
24: Fixing unit
25: Paper exit roller
26: Paper exhaust tray
70: Endless belt-shaped intermediate transfer body
71, 72, 73, 74: Rollers
82L, 82R: Support rail
P: Transfer material

What is claimed is:

1. A two-component developer for electrostatic charge image development comprising: toner particles containing toner base particles and an external additive disposed on a surface of the toner base particles; and carrier particles having a core material particle and a shell portion disposed on a surface of the core material particles,
wherein the external additive contains inorganic particles surface-modified with a surface modifier represented by the following Formula (1); and
a value of an iron element content (atomic %) measured by X-ray photoelectron spectroscopy (XPS) on a surface of the carrier particles satisfies the following Expression (1),
(R₁)₄₋ₙ—Si—(X)ₙ Formula (1):
in Formula (1), R₁ represents a linear alkyl group having 1 to 4 carbon atoms which may have a substituent; X is a halogen atom or an alkoxy group, and when there are a plurality of Xs, the plurality of Xs may be the same or different from each other; and n represents an integer of 1 to 3,
4.0≤{A_{Fe}/(A_{c}+Aₒ+A_{Fe})}×100≤15.0 Expression (1):
in Expression (1), A_{Fe}, A_{c}, and Aₒ, each represent a content (atomic %) of Fe, C, and C in an unit area of the surface of the carrier particles.

2. The two-component developer for electrostatic charge image development according to claim 1, wherein the external additive is selected one from the group consisting of silica particles, alumina particles and titanic acid compound particles.

3. The two-component developer for electrostatic charge image development according to claim 1, wherein a shape coefficient (SF-1) of the core material particle is in the range of 115 to 150.

4. The two-component developer for electrostatic charge image development according to claim 1, wherein the toner base particle has a core-shell structure.

5. The two-component developer for electrostatic charge image development according to claim 4, wherein the core-shell structure has a core portion made of an amorphous vinyl resin as a main component, and a shell portion made of an amorphous polyester resin as a main component.

6. A method of forming an electrophotographic image comprising the steps of: a charging an image carrier, forming an electrostatic charge image, developing the electrostatic charge image, transferring a toner image, fixing the toner image, and cleaning the image carrier,
wherein the two-component developer for electrostatic charge image development according to claim 1 is used to form the toner image.

7. An electrophotographic image forming apparatus comprising: a charging unit of an image carrier, an electrostatic charge image forming unit, an electrostatic charge image developing unit, a toner image transferring unit, a toner image fixing unit, and a cleaning unit,
wherein the electrophotographic image forming apparatus uses the two-component developer for electrostatic charge image development according to claim 1.
